(19) United States
(12) Patent Application Publication
(10) Pub. No.: US 2010/0289737 A1
(43) Pub. Date: Nov. 18, 2010

(54) PORTABLE ELECTRONIC APPARATUS, OPERATION DETECTING METHOD FOR THE PORTABLE ELECTRONIC APPARATUS, AND CONTROL METHOD FOR THE PORTABLE ELECTRONIC APPARATUS

(75) Inventors: Taro IIO, Kanagawa (JP); Tomokazu Ohta, Yokohama-shi (JP)

Correspondence Address: Hogan Lovells US LLP, 1999 AVENUE OF THE STARS, SUITE 1400, LOS ANGELES, CA, 90067, US

(73) Assignee: Kyocera Corporation, Kyoto (JP)

(21) Appl. No.: 12/438,707

(22) PCT Filed: Jul. 30, 2007
(86) PCT No.: PCT/JP2007/064908

§ 371 Date: Jul. 22, 2010

(30) Foreign Application Priority Data
Aug. 25, 2006 (JP) 2006-229383
Aug. 25, 2006 (JP) 2006-229528

(51) Int. Cl. G09G 5/00; H04L 17/02

(52) U.S. Cl. 345/156; 341/176

(57) ABSTRACT

A portable electronic apparatus includes; plural sensor elements L1 to L4 and R1 to R4 that are annularly arranged and contact with which is detected; and a control unit 110 that monitors outputs of the plural sensor elements and executes control based on a change in the sensor elements, contact with which is detected. The control unit 110 detects one turn of touch operation when contact is detected in one sensor element L1 in the plural sensor elements L1 to L4 and R1 to R4 and, with the position of the one sensor element L1 set as an origin, contact is continuously detected up to the sensor element L1 in the position of the origin from the origin in a predetermined turning direction or up to the sensor element R4 in a position a predetermined number of sensor elements before the origin in the predetermined turning direction.

### CROSS REFERENCE TO RELATED APPLICATIONS

This application claims the priority from Japanese Patent Applications 2006-229383 and 2006-229528 filed on Aug. 25, 2006, entire contents of which are incorporated herein for reference.

### TECHNICAL FIELD

The present invention relates to a portable electronic apparatus, and more particularly, to a portable electronic apparatus in which plural sensor elements that detect contact are annularly arranged as an operation input unit, an operation detecting method therefor, and a control method therefor.

### BACKGROUND ART

Conventionally, various interfaces and configurations have been developed as the operation input units of portable electronic apparatuses. For example, Japanese Patent Laid-Open No. 2003-280792 discloses a portable electronic apparatus in which a rotary dial input device is provided and a cursor displayed on a display unit is moved according to a rotation amount of the rotary dial input device.

However, in the technique disclosed in Japanese Patent Laid-Open No. 2003-280792, since a “rotary dial” involving physical and mechanical rotations is used, there is a problem in that malfunctions, failures, and the like tend to be caused by mechanical abrasion and the like, maintenance for the operation input unit is necessary, and a period of endurance is short.

As a technique that can solve such a problem, for example, Japanese Patent Laid-Open Nos. 2005-522797 and 2004-311196 disclose an input device in which touch sensor elements not involving physical and mechanical rotations are used in an operation input unit. In this proposed technique, plural touch sensor elements are annularly arranged, contact detection by the respective touch sensor elements is monitored, and, when continuous contact detection is sensed, it is determined according to movement of a place of the contact detection that a moving instruction for a cursor is generated, and the cursor is moved.

In portable electronic apparatuses in recent years, application programs (hereinafter simply referred to as applications as well) to be processed are diversified and input operation by users are required to be diversified according to the diversification of the applications.

However, in the technique disclosed in Japanese Patent Laid-Open Nos. 2005-522797 and 2004-311196, processing for merely sensing whether the annularly-arranged plural touch sensor elements are touch-operated in a forward direction or touch-operated in a reverse direction and moving the cursor in one or the other of two directions according to the sensed direction is performed. Therefore, it is anticipated that the technique cannot cope with the application requiring a predetermined numbers of times of turning and lacks universality.

### SUMMARY OF INVENTION

Therefore, a first object of the present invention devised in view of such circumstances is to provide an excellent portable electronic apparatus having operability, which is simple and new for a user, for tracing plural annularly-arranged sensor elements, which detect contact, one turn and an operation detecting method for the portable electronic apparatus.

Further, a second object of the present invention is to provide a portable electronic apparatus excellent in universality that can detect a forward and reverse turning operation with respect to plural annularly-arranged sensor elements, contact with which is detected, and can easily cope with various applications and a control method for the portable electronic apparatus.

An invention of a portable electronic apparatus according to a first aspect for attaining the first object is a portable electronic apparatus including:
plural sensor elements that are annularly arranged and contact with which is detected; and
a control unit that monitors outputs of the plural sensor elements and executes control based on a change in the sensor elements, contact with which is detected, characterized in that
the control unit detects one turn of touch operation when contact is detected in one sensor element in the plural sensor elements and, with the position of the one sensor element set as an origin, contact is detected in plural sensor elements in a predetermined turning direction from the origin, and contact is continuously detected up to a sensor element in a position a predetermined number of sensor elements before the origin.

An invention according to a second aspect is characterized in that, in the portable electronic apparatus according to the first aspect, the control unit detects the next turn of touch operation when, after the one turn of touch operation is detected, contact is continuously detected in the predetermined turning direction through the origin in order up to the plural sensor elements to the position the predetermined number of sensor elements before the origin through the origin.

An invention according to a third aspect is characterized in that, in the portable electronic apparatus according to the second aspect, the control unit sets the origin in detecting the next turn of touch operation in the position of the one sensor element.

An invention according to a fourth aspect is characterized in that, in the portable electronic apparatus according to the first aspect, the control unit can sense, for each of the plural sensor elements, a single element detection state in which contact is detected only in a single sensor element and a plural element detection state in which contact is detected in all plural sensor elements adjacent to one another and sets, when a plural element contact state by the one sensor element and another sensor element adjacent to the one sensor element in the predetermined turning direction is sensed, the position of the one sensor element as the origin.

An invention according to a fifth aspect is characterized in that, in the portable electronic apparatus according to the fourth aspect, the control unit senses a detection state of plural elements including the sensor element in the position the predetermined number of sensor elements before the origin and a sensor element adjacent to the sensor element and further in the front in the turning direction and detects the one turn of touch operation.

An invention according to a sixth aspect is characterized in that, in the portable electronic apparatus according to the first aspect, the position the predetermined number of sensor elements before the origin is a position one sensor element before the origin in the turning direction.

An invention of a portable electronic apparatus according to a seventh aspect for attaining the first object is a portable electronic apparatus including:
plural sensor elements that are annularly arranged and contact with which is detected; and
a control unit that monitors outputs of the plural sensor elements and executes control based on a change in the sensor elements, contact with which is detected, characterized in that
the control unit detects one turn of touch operation when contact is detected in one sensor element in the plural sensor elements and, with the position of the one sensor element set as an origin, contact is continuously detected up to the sensor element in the position of the origin from the origin in a predetermined turning direction.

An invention according to an eighth aspect is characterized in that, in the portable electronic apparatus according to the seventh aspect, the control unit detects the next turn of touch operation when, after the one turn of touch operation is detected, contact is further continuously detected in plural sensor elements in order up to the position of the origin through the origin in the predetermined turning direction.

An invention according to a ninth aspect is characterized in that, in the portable electronic apparatus according to the seventh aspect, the control unit can sense, for each of the plural sensor elements, a single element detection state in which contact is detected only in a single sensor element and a plural element detection state in which contact is detected in all plural sensor elements adjacent to one another and sets, when a plural element contact state by the one sensor element and another sensor element adjacent to the one sensor element in the predetermined turning direction is sensed, the position of the one sensor element as the origin.

An invention according to a tenth aspect is characterized in that, in the portable electronic apparatus according to the first aspect, the control unit detects the one turn of touch operation within a predetermined time after contact as the origin is detected.

An invention according to an eleventh aspect is characterized in that, in the portable electronic apparatus according to the first aspect,
the portable electronic apparatus has a display unit, display contents on which are changed by the control unit according to detection results of the plural sensor elements, and
the control unit detects touch operation of the one sensor element on condition that display by the display unit is performed.

Further, an invention of an operation detecting method for a portable electronic apparatus according to a twelfth aspect for attaining the first object is an operation detecting method characterized by including: monitoring outputs of plural sensor elements that are annularly arranged in a portable electronic apparatus and contact with which is detected; and detecting one turn of touch operation when contact is detected in one sensor element in the plural sensor elements and, with the position of the one sensor element set as an origin, contact is continuously detected in plural sensor elements up to a position a predetermined number of sensor elements before the origin in a predetermined turning direction up to the origin or from the origin.

Moreover, an invention of a portable electronic apparatus according to a thirteenth aspect for attaining the second object is a portable electronic apparatus including:
plural sensor elements that are annularly arranged and contact with which is detected; and
a control unit that monitors outputs of the plural sensor elements and executes control based on a change in the sensor elements, contact with which is detected, characterized in that
the control unit detects a predetermined turn including a forward and reverse turn in which a first direction turn and a second direction turn are continuous, the plural sensor elements continuously detecting contact in order in the first turning direction in the first direction turn and continuously detecting contact in order in the second direction opposite to the first turning direction in the second direction turn, and makes predetermined control executable.

An invention according to a fourteenth aspect is characterized in that, in the portable electronic apparatus according to the thirteenth aspect, the control unit detects the predetermined turn within a predetermined time after contact is detected in one sensor element in the plural sensor elements and executes the predetermined control.

An invention according to a fifteenth aspect is characterized in that, in the portable electronic apparatus according to the thirteenth aspect, the control unit sets an origin in detecting one turn in the first direction turn and an origin in detecting one turn in the second direction turn the same and detects the forward and reverse turn.

An invention according to a sixteenth aspect is characterized in that, in the portable electronic apparatus according to the fifteenth aspect, the control unit can further continuously detect, as the predetermined turn, after detecting a forward and reverse turn continuous from one turn in the first direction turn to one turn in the second direction turn, one turn in the first direction turn from the origin.

An invention according to a seventeenth aspect is characterized in that, in the portable electronic apparatus according to the fifteenth aspect, the control unit can further continuously detect, as the predetermined turn, after detecting a forward and reverse turn continuous from one turn in the first direction turn to one turn in the second direction turn, one turn in the second direction turn from the origin.

An invention according to an eighteenth aspect is characterized in that, in the portable electronic apparatus according to the thirteenth aspect, the control unit sets an origin in detecting one turn in the second direction turn in a position changed from the first direction turn to the second direction turn.

An invention according to a nineteenth aspect is characterized in that, in the portable electronic apparatus according to the eighteenth aspect, the control unit sets, in further continuously detecting the first direction turn as the predetermined turn after detecting a forward and reverse turn continuous from one turn in the first direction turn to one turn in the second direction turn, an origin of the detection in a position changed from the second direction turn to the first direction turn.

An invention according to a twentieth aspect is characterized in that, in the portable electronic apparatus according to the eighteenth aspect, the control unit can detect, in further continuously detecting the second direction turn as the predetermined turn after detecting a forward and reverse turn continuous from one turn in the first direction turn to one turn in the second direction turn, one turn in the second direction turn from the origin.

An invention according to a twenty-first aspect is characterized in that, in the portable electronic apparatus according to the thirteenth aspect, the control unit determines the first turning direction or the second turning direction on the basis of a temporal change in outputs of the plural sensor elements and determines the first direction turn and the second direction turn in which contact in the first turning direction or the second turning direction is continuous.

An invention according to a twenty-second aspect is characterized in that, in the portable electronic apparatus according to the thirteenth aspect,
the portable electronic apparatus further includes a display unit, an operation unit, and a storing unit, and
the control unit causes, according to predetermined operation by the operation unit, the display unit to display a screen for setting a turning direction and the number of times of turn in the plural sensor elements and causes, when conditions are set by the operation unit or the plural sensor elements on the screen, the storing unit to store the conditions as conditions for executing the predetermined control.

Furthermore, an invention of a control method for a portable electronic apparatus according to a twenty-third aspect for attaining the second object is a control method characterized by including: monitoring outputs of plural sensor elements that are annularly arranged in a portable electronic apparatus and contact with which is detected; and detecting a predetermined turn including a forward and reverse turn in which a first direction turn and a second direction turn are continuous, the plural sensor elements continuously detecting contact in order in the first turning direction in the first direction turn and continuously detecting contact in order in the second direction opposite to the first turning direction in the second direction turn, and executing predetermined control.

### BRIEF DESCRIPTION OF DRAWINGS

FIG. 1 is a block diagram showing a basic configuration of a cellular phone terminal according to a first embodiment of the present invention;

FIG. 2 is a perspective view of the cellular phone terminal according to the first embodiment;

FIG. 3 is a detailed functional block diagram of the cellular phone terminal according to the first embodiment;

FIG. 4 is a block diagram showing a more detailed configuration of a touch sensor function of the cellular phone terminal according to the first embodiment;

FIG. 5 is a plane view showing the arrangement of components of a sensor unit and a sub-display unit of the cellular phone terminal shown in FIG. 2;

FIG. 6 is a disassembled perspective view of FIG. 5;

FIG. 7 is a schematic block diagram for explaining processing of contact detection data from respective sensor elements in the cellular phone terminal according to the first embodiment;

FIG. 8 is a diagram for explaining operations in a “half-turn detection mode” in the cellular phone terminal according to the first embodiment;

FIG. 9 is a diagram for explaining operations in the “half-turn detection mode” in the cellular phone terminal according to the first embodiment;

FIG. 10 is a conceptual diagram showing other sensor element detection states;

FIG. 11 is a flowchart for explaining operation in another “half-turn detection mode” to which sixteen sensor element detection states shown in FIG. 10 are applied;

FIG. 12 is a diagram for explaining fixing processing in the case in which processing of the flowchart shown in FIG. 11 is applied to contact with sensor elements L1 to L4 shown in FIG. 10;

FIG. 13 is a conceptual diagram for explaining operations in a “turn detection mode” in the cellular phone terminal according to the first embodiment;

FIG. 14 is a flowchart for explaining the operations in the “turn detection mode”;

FIG. 15 is a plan view showing the arrangement of components of the sensor unit and the sub-display unit of the cellular phone terminal according to a second embodiment of the present invention;

FIG. 16 is a disassembled perspective view of FIG. 15;

FIG. 17 is a diagram for explaining an example of release condition setting for a communication function lock by the cellular phone terminal according to the second embodiment;

FIG. 18 is a conceptual diagram for explaining operations in a “turn detection mode” in the cellular phone terminal according to the second embodiment; and

FIG. 19 is a flowchart for explaining the operations in the “turn detection mode”.

### DESCRIPTION OF EMBODIMENTS

Embodiments of the present invention are explained with reference to the drawings. In the following explanation, the present invention is applied to a cellular phone terminal as a typical example of a portable electronic apparatus.

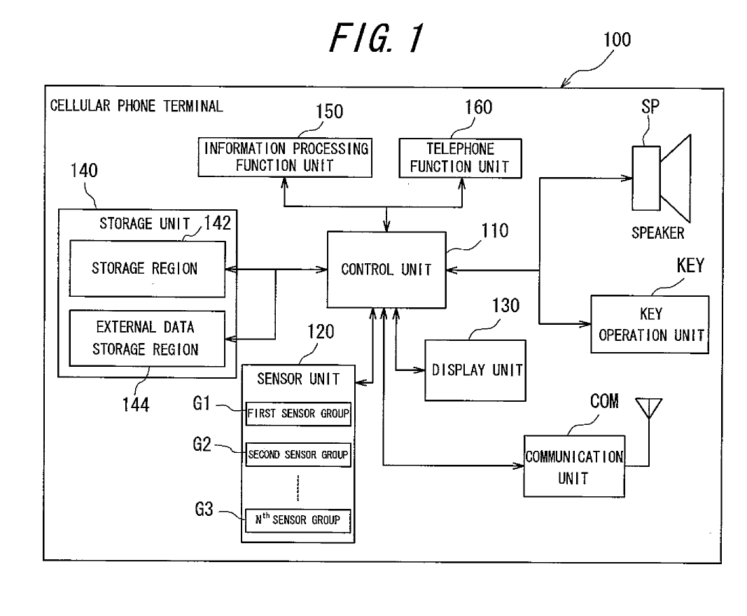

(First Embodiment) FIG. 1 is a block diagram showing a basic configuration of a cellular phone terminal according to a first embodiment of the present invention. This cellular phone terminal 100 includes a control unit 110, a sensor unit 120, a display unit 130, a storing unit (a flash memory, etc.) 140, an information processing function unit 150, a telephone function unit 160, a key operation unit KEY, a speaker SP, and a communication unit COM that is connected to a not-shown CDMA communication network and performs communication. Further, the sensor unit 120 includes, according to an application, “n” sensor element groups including plural sensor elements (e.g., a contact sensor, a detecting section of which is provided on an outer surface of a apparatus casing, and that detects contact and approach of an object such as a finger), i.e., a first sensor element group G1, a second sensor element group G2, and an nth sensor element group G3. The storing unit 140 includes a storage region 142 and an external data storage region 144. The control unit 110 and the information processing function unit 150 preferably include arithmetic means such as CPUs and software modules. Besides a serial interface unit SI, an RFID module RFID and an infrared-ray communication unit IR connected to the control unit 110 via the serial interface unit SI, and a camera 220 and a light 230 explained later, a microphone MIC, a radio module RM, a power supply PS, a power supply controller PSCON, and the like are connected to the control unit 110. However, these components are omitted in order to simplify the drawing.

The control unit 110 detects, with the sensor unit 120, contact of an object by a finger of a user, stores detected information in the storage region 142 of the storing unit 140, and controls, with the information processing function unit 150, processing for the stored information. The control unit 110 causes the display unit 130 to display information corresponding to a processing result. Further, the control unit 110 controls the telephone function unit 160 for a normal call function, the key operation unit KEY, and the speaker SP. The display unit 130 includes a sub-display unit ELD and a not-shown main display unit (a display unit provided in a position where the display unit is hidden in a closed state of the cellular phone terminal 100 and is exposed in an opened state of the cellular phone terminal 100).

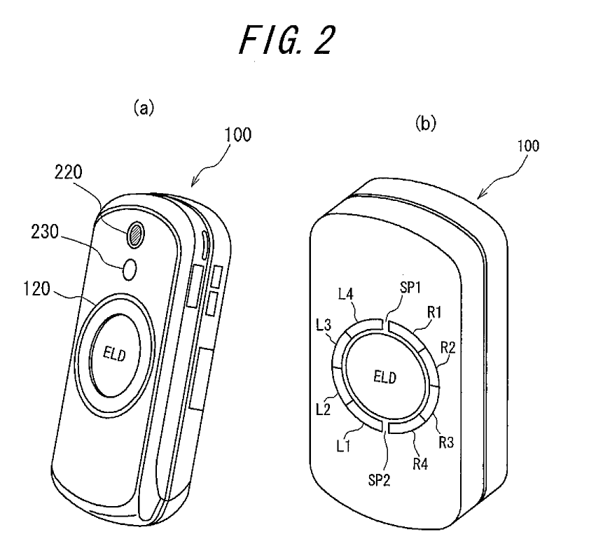

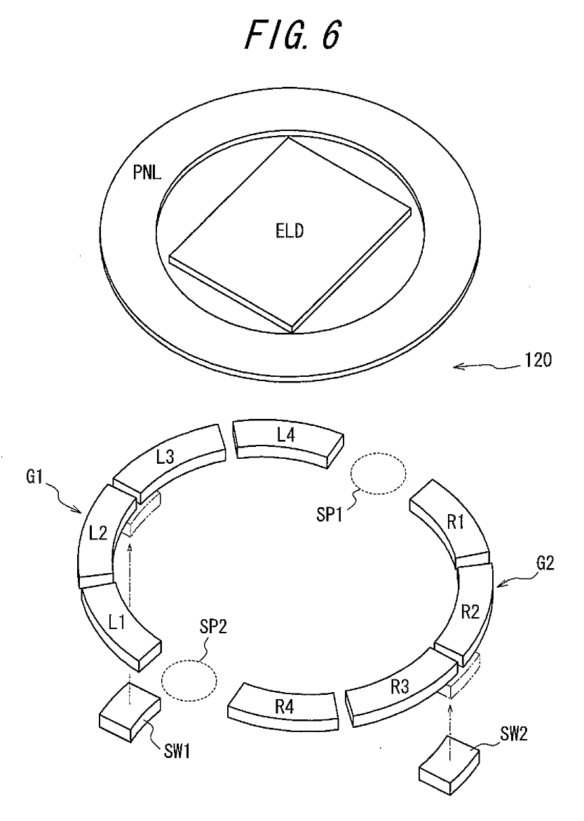

FIG. 2 is a diagram showing an external appearance of the cellular phone terminal according to this embodiment. FIG. 2(a) is a perspective view of the entire cellular phone terminal. FIG. 2(b) is a perspective view in which a panel PNL is omitted and the arrangement of only sensor elements and the periphery of the sub-display unit ELD is displayed to illustrate the operation of a sensor unit 120. The cellular phone terminal 100 includes the sensor unit 120 (on an external appearance, the panel PNL explained later with reference to FIG. 6 that covers the sensor unit 120, i.e., the sensor element groups G1 and G2 is seen), the camera 220, and the light 230. In the cellular phone terminal 100, besides a closed state shown in FIG. 2, a hinge section can be pivoted and slid to form an opened state. The sensor unit 120 is provided in a position where the sensor unit 120 can be operated even in the closed state. Sensor elements L1 to L4 and R1 to R4 include contact sensors of an electrostatic capacitance type and are arranged side by side in an annular shape along the circumference of the sub-display unit ELD including an organic EL display.

The sensor elements L1 to L4 configure the first sensor element group G1. The sensor elements R1 to R4 configure the second sensor element group G2. In other words, in this embodiment, the sensor unit 120 includes the first sensor element group G1 and the second sensor element group G2. The first sensor element group G1 and the second sensor element group G2 are arranged side by side across the sub-display unit ELD while being separated by separating sections SP1 and SP2 in a line symmetrical layout with a direction of the arrangement of selection candidate items set as a center line. The sub-display unit ELD is not limited to the organic EL display. For example, a liquid crystal display can also be used as the sub-display unit ELD. The sensor elements L1 to L4 and R1 to R4 are not limited to the contact sensors of the electrostatic capacitance type. Contacts sensors of a thin-film resistance type can also be used as the sensor elements L1 to L4 and R1 to R4.

In FIG. 2, the sub-display unit ELD displays information according to an application being executed in the cellular phone terminal 100. For example, during the execution of an application of a music player, titles of pieces of music that can be played are displayed on the sub-display unit ELD. A set of a name of a tune and an artist name forms one item, i.e., a “selection candidate item”. The user operates the operation input unit and the sensor unit 120 to change electrostatic capacitances of the sensor elements R1 to R4 and L1 to L4, move items displayed on the sub-display unit ELD and an operation target area, and perform selection of a title of a piece of music. In this case, if the sensor elements are arranged around the sensor display unit ELD as shown in FIG. 2, the sensor unit 120 does not occupy a large area of a mounting portion in an outer casing of a small portable electronic apparatus. The user can operate the sensor elements while looking at the display of the sensor display unit ELD.

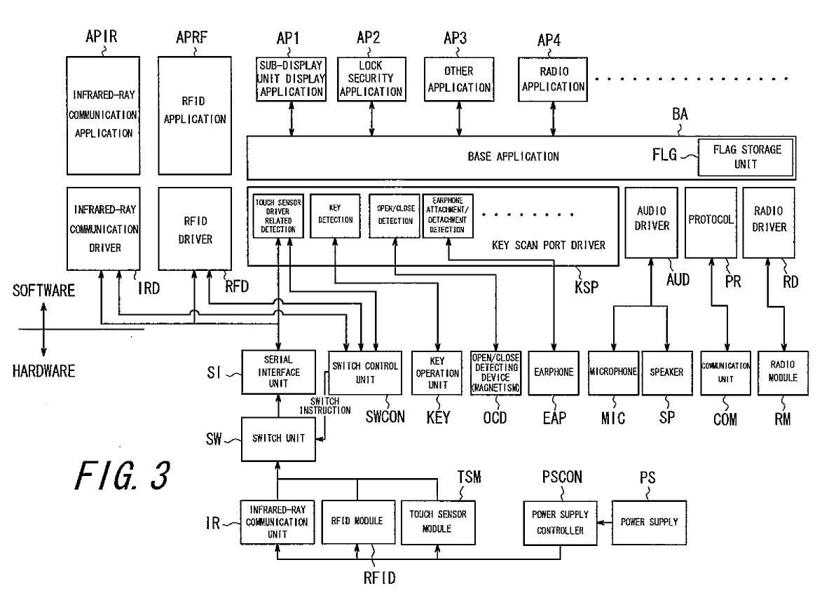

FIG. 3 is a detailed functional block diagram of the cellular phone terminal 100 according to this embodiment. It goes without saying that various kinds of software shown in FIG. 3 operate by being executed by the control unit 110 on the basis of programs stored in the storing unit 140 after a work area is provided on the same storing unit 140. As shown in the figure, functions of the cellular phone terminal 100 are divided into a software block and a hardware block. The software block includes a base application BA having a flag storing section FLG, a sub-display section display application AP1, a lock security application AP2, other applications AP3, and a radio application AP4. The software block further includes an infrared-ray communication application APIR and an RFID application APRF. When these applications control various kinds of hardware of the hardware block, the applications use an infrared-ray communication driver IRD, an RFID driver RFD, an audio driver AUD, a radio driver RD, and a protocol PR as drivers. F or example, the audio driver AUD, the radio driver RD, and the protocol PR respectively control the microphone MIC, the speaker SP, the communication unit COM, and the radio module RM. The software block further includes a key scan port driver KSP that monitors and detects an operation state of the hardware and performs touch sensor driver related detection, key detection, open/close detection for detecting open and close of cellular phone terminals of a folding type and a slide type, earphone attachment and detachment detection, and the like.

The hardware block includes the key operation unit KEY including various buttons including a dial key and tact switches SW1 to SW4 explained later, an open/close detection device OCD that detects open and close on the basis of an operation state or the like of the hinge section, the microphone MIC attached to an apparatus main body, a detachable earphone EAP, the speaker SP, the communication unit COM, the radio module RM, the serial interface unit SI, and a switching control unit SWCON. The switching control unit SWCON selects, according to an instruction from a relevant block of the software block, any one of the infrared-ray communication unit IR, the RFID module (a radio identification tag) RFID, and a touch sensor module TSM (a module of the sensor unit 120 and a set of components necessary in driving the sensor unit 120 such as an oscillation circuit) to form a first and a second sensor element groups G1 and G2 and switches the selection target pieces of hardware (IR, RFID, and TSM) such that the serial interface unit SI picks up a signal of the selection. The power supply PS supplies power to the selection target pieces of hardware (IR, RFID, and TSM) via the power supply controller PSCON.

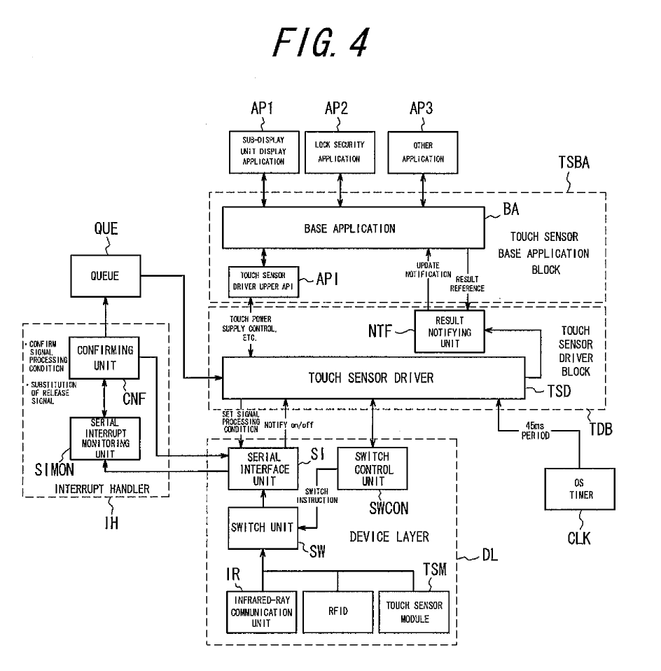

FIG. 4 is a block diagram showing a more detailed configuration of the touch sensor function of the cellular phone terminal 100 according to this embodiment. The cellular phone terminal 100 includes a touch sensor driver block TDB, a touch sensor base application block TSBA, a device layer DL, an interrupt handler IH, a queue QUE, an OS timer CLK, and various applications AP1 to AP3. The touch sensor base application block TSBA includes a base application BA and a touch sensor driver upper application interface API. The touch sensor driver block TDB includes a touch sensor driver TSD and a result notifying unit NTF. The device layer DL includes the switching control unit SWCON, a switching unit SW, the serial interface unit SI, the infrared-ray communication unit IR, the RFID, and the touch sensor module TSM. The interrupt handler IH includes a serial interrupt monitoring unit SIMON and a confirming unit CNF.

Next, functions of the respective blocks are explained. In the touch sensor base application block TSBA, the base application BA and the touch sensor driver upper application interface API communicate each other about whether the touch sensor module TSM should be started. The base application BA is an application as a base of the lock secure application AP2 and the other applications AP3 that are applications for locking the cellular phone terminal 100 for security protection of an accounting service employing the sub-display unit display application AP1, which is an application for a sub-display unit, and the RFID. When the base application BA is requested by the respective applications to start a touch sensor, the base application BA requests the touch sensor driver upper application interface API to start the touch sensor module TSM. The sub-display unit is the sub-display unit ELD shown in the respective figures and indicates the sub-display unit ELD provided in a center area of the sensor element group annularly arranged in the cellular phone terminal 100 in this embodiment.

When a request for the start of the touch sensor module TSM is received, the touch sensor driver upper application interface API checks with a block (not shown), which manages the start of applications in the base application BA, whether the start of the touch sensor module TSM is possible. The touch sensor driver upper application interface API checks presence or absence of lighting of the sub-display unit ELD indicating that selection of an application is executed or a flag indicating the start of an application, for which the start of the touch sensor module TSM is set impossible in advance, such as an FM radio or other applications attached to the cellular phone terminal 100. As a result, when it is determined that the start of the touch sensor module TSM is possible, the touch sensor driver upper application interface API requests the touch sensor driver TSD to start the touch sensor module TSM. In other words, practically, the touch sensor driver upper application interface API starts power supply from the power supply PS to the touch sensor module TSM via the power supply controller PSCON.

When the start of the touch sensor module TSM is started, the touch sensor driver TSD requests the serial interface unit SI in the device layer DL to perform control to open a port to the touch sensor driver TSD in the serial interface unit SI.

Thereafter, the touch sensor driver TSD performs control such that a signal having information concerning a sensing result of the touch sensor module TSM (hereinafter referred to as contact signal) is output to the serial interface unit SI at a period of 20 ms by an internal clock of the touch sensor module TSM.

The contact signal is output as an 8-bit signal corresponding to each of the eight sensor elements, i.e., the sensor elements L1 to L4 and R1 to R4. When each of the sensor elements senses contact, the contact signal is a signal formed by setting “flag: 1” representing the contact detection in bits corresponding to the sensor element that sense the contact. The contact signal is formed by a string of these bits. In other words, information indicating “which of the sensor elements” is “contact or non-contact” is included in the contact signal.

The serial interrupt monitoring unit SIMON in the interrupt handler IH extracts the contact signal output to the serial interface unit SI. The confirming unit CNF performs confirmation of True/False of the extracted contact signal according to conditions set in advance in the serial interface unit SI and inputs only data of a True signal to the queue QUE (classification of True/False of a signal is explained later). The serial interrupt monitoring unit SIMON also performs monitoring of other interrupt events of the serial interface unit SI during the start of the touch sensor module TSM such as occurrence of depression of a tact switch explained later in the touch sensor module TSM.

When the detected contact is first contact, the monitoring unit SIMON inputs a signal meaning “press” to the queue QUE before the contact signal (queuing). Thereafter, the monitoring unit SIMON performs update of the contact signal at a 45 ms period according to a clock by an OS timer CLK of an operation system. When contact is not detected for a predetermined period, the monitoring unit SIMON inputs a signal meaning “release” to the queue QUE. This makes it possible to monitor movement of contact detection among the sensor elements from the start of contact until the release. The “first contact” indicates an event in which a signal having “flag: I” is generated in a state in which there is not data in the queue QUE or when nearest input data is “release”. According to these kinds of processing, the touch sensor driver TSD can learn a detection state of the sensor elements in a section from “press” to “release”.

At the same time, when the contact signal output from the touch sensor module TSM is a signal satisfying conditions for being False, the monitoring unit SIMON simulatively generates a signal meaning “release” and inputs the signal to the queue QUE. As the conditions for being False, “when contact is detected by discontinuous two sensor elements”, “when interrupt occurs during the start of the touch sensor module TSM (e.g., a turn-on/turn-off state of the sub-display unit ELD is changed according to notification of mail reception or the like), “when key depression occurs during the start of the touch sensor module TSM”, or the like is set.

For example, contact is simultaneously detected by adjacent two sensor elements such as the sensor elements R2 and R3, as in the case in which a single element is detected, the monitoring unit SIMON inputs a contact signal with a flag set in bits corresponding to the elements that detect the contact to the queue QUE.

The touch sensor driver TSD reads out the contact signal from the queue QUE at a 45 ms period and determines, according to the read-out contact signal, the elements that detect the contact. The touch sensor driver TSD determines “an element from which contact is started”, “a moving direction (clockwise/counterclockwise)”, and “a moving distance from press to release” taking into account a change in the contact determined by contact signals sequentially read out from the queue QUE and a positional relation with the elements that detect the contact. The touch sensor driver TSD writes a result of the determination in the result notifying unit NTF and notifies the base application BA to update the result.

In this embodiment, a “half-turn detection mode” and a “turn detection mode” are provided as detection modes for a moving direction and a moving distance of contact by a contact signal. The “half-turn detection mode” and the “turn detection mode” are selectively applied according to an application being executed. Details of the detection modes are explained later.

As explained above, when the update of the result is notified to the base application BA by the touch sensor driver TSD, the base application BA checks the result notifying unit NTF and notifies higher-order applications requiring a touch operation result of the touch sensor module TSM (the sub-display unit display application AP1 for menu screen display in the sub-display unit, the lock security application AP2 for lock control, etc.) of contents of information notified to the result notifying unit NTF.

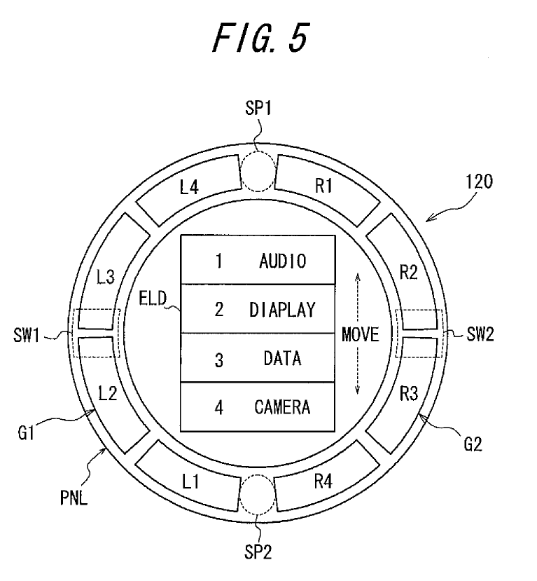

FIG. 5 is a plan view showing the arrangement of components of, in particular, the sensor unit 120 and the sub-display unit ELD of the cellular phone terminal 100 according to this embodiment. For convenience of illustration and explanation, only a UNIT of the components are illustrated and explained. As shown in the figure, the annular panel PNL is arranged along the circumference of the sub-display unit ELD including organic EL elements. The panel PNL is suitably formed sufficiently thin not to affect the sensitivity of sensor elements provided below the panel PNL. Below the panel PNL, the eight sensor elements L1 to L4 and R1 to R4 of the electrostatic capacitance type, which can sense contact/approach of a finger of a human body, are arranged substantially annularly. The four sensor elements L1 to L4 on the left side configure the first sensor element group G1 and the four sensor elements R1 to R4 on the right side configure the second sensor element group G2. Clearances (spaces) are provided and arranged among adjacent sensor elements in the respective sensor element groups such that the adjacent sensor elements do not interfere with a contact detection function. When sensor elements of a non-interfering type are used, the clearances are unnecessary.

A separation section SP1 as a clearance larger than (e.g., twice or more as long as) the clearances among the adjacent sensor elements in the same sensor element group is provided between the sensor element L4 located at one end of the first sensor element group G1 and the sensor element R1 located at one end of the second sensor element group G2. A separation section SP2 same as the separation section SP1 is provided between the sensor element L1 located at the other end of the first sensor element group G1 and the sensor element R4 located at the other end of the second sensor element group G2. With such separation sections SP1 and SP2, it is possible to prevent fingers from interfering with each other when the first sensor element group G1 and the second sensor element group G2 are caused to separately function.

The respective sensor elements of the first sensor element group G1 are arranged in an arc shape. The center of the tact switch SW1 is arranged below the center of this arc, i.e., the middle of the sensor elements L2 and L3. Similarly, the center of the tact switch SW2 is arranged below the center of an arc formed by the respective sensor elements of the second sensor element group G2, i.e., the middle of the sensor elements R2 and R3 (see FIG. 6).

Since the tact switches are arranged in substantially the centers in the arranging direction of the sensor element groups, which are in positions not causing a user to associate the switches with directionality, the user can easily grasp that tact switches are switches for performing operation not directly related to a direction indication by moving indication operation having directionality of a finger by the user on the sensor elements. In other words, if the tact switches are arranged at ends (e.g., L1 and L4) rather than in the centers in the arranging directions of the sensor element groups, since this causes the user to associate the switches with directionality toward the end sides, the user tends to misunderstand that the tact switches are “switches” that are pressed long in order to, for example, continue a moving operation by the sensor elements. On the other hand, if the tact switches are arranged in the center in the arranging directions of the sensor element groups as in this embodiment, it is possible to prevent such misunderstanding and provide a more comfortable user interface. Since the tact switches are arranged below the sensor elements and are not exposed to the outer surface of the apparatus, as the external appearance of the apparatus, the number of points of the operation unit exposed to the outside can be reduced. This gives the user a sophisticated impression in that complicated operation is not required. When the switches are provided in places other than below the panel PNL, it is necessary to separately provide through holes in the casing of the apparatus. However a fall in casing strength could occur depending on positions where the through holes are provided. In this configuration, since the tact switches are arranged below the panel PNL and the sensor elements, it is unnecessary to provide new through holes and it is possible to prevent the fall in housing strength.

For example, during execution of the sub-display unit display application AP1 for displaying a menu screen on the sub-display unit ELD, for example, when the user sequentially traces the sensor elements L1, L2, L3, and L4 with a finger in an arc shape upward, an item displayed as a selection target area (reversing display, highlighting display in a different color, etc.) among selection candidate items (in this case, sound, display, data, camera) displayed on the display unit ELD is sequentially changed to items displayed above or the selection candidate items are scrolled upward. When a desired selection candidate item is displayed as the selection target area, the user can depress the tact switch SW1 across the panel PNL and the sensor elements L2 and L3 to perform selection determination or can depress the tact switch SW2 to change display itself to another screen. In other words, the panel PNL has flexibility sufficient for depressing the tact switches SW1 and SW2 or is attached to the apparatus casing to be slightly tiltable and has a role of a plunger for the tact switches SW1 and SW2.

FIG. 6 is a disassembled perspective view of the components, in particular, the sensor unit 120 of the cellular phone terminal 100 shown in FIGS. 2 and 5. As shown in the figure, the panel PNL and the sub-display unit ELD are arranged in a first layer forming the outer surface of the terminal casing. The sensor elements L1 to L4 and R1 to R4 are arranged in a second layer located below the panel PNL in the first layer. The tact switches SW1 and SW2 are arranged in a third layer located below a space between the sensor elements L2 and L3 in the second layer and below a space between the sensor elements R2 and R3.

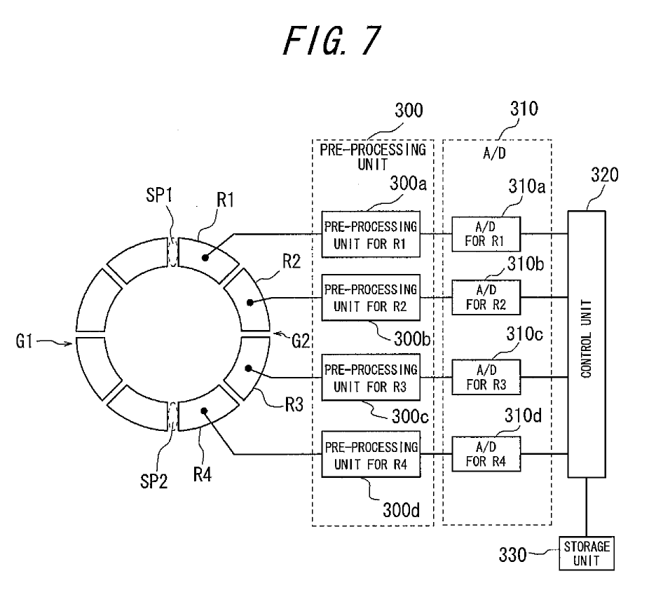

FIG. 7 is a schematic block diagram for explaining processing of contact detection data from the respective sensor elements. For simplification of explanation, only the sensor elements R1 to R4 are shown. However, the same applies to the sensor elements L1 to L4. A high frequency is applied to each of the sensor elements R1 to R4. A pre-processing unit 300 (a pre-processing unit for R1 300a, a pre-processing unit for R2 300b, a pre-processing unit for R3 300c, and a pre-processing unit for R4 300d) calibrates each of the sensor elements R1 to R4 taking into account a change in a fixed stray capacitance, sets a high frequency state at this point as a reference, and detects fluctuation in the high frequency state based on a change in an electrostatic capacitance due to contact of a finger or the like. A detection signal by the pre-processing unit 300 is transmitted to an A/D converter 310 (an A/D converter for R1 310a, an A/D converter for R2 310b, an A/D converter for R3 310c, and an A/D converter for R4 310d) and converted into a digital signal indicating contact detection. The digitized signal is transmitted to the control unit 320 and combined with signals of the other sensor elements L1 to L4 to obtain an 8-bit contact signal. The 8-bit contact signal is converted into, for example, a hexadecimal signal and stored in the storing unit 330. Thereafter, the contact signal is transmitted to the serial interface unit and the interrupt handler and, after being converting into a signal readable by the touch sensor driver in the interrupt handler, the signal after the conversion is input to the queue. The control unit 320 performs, on the basis of information stored in the storing unit 330, detection of a direction at a point when contact is detected in two or more adjacent sensor elements.

Next, the “half-turn detection mode” and the “turn detection mode” by the cellular phone terminal 100 according to this embodiment are explained.

First, the “half-turn detection mode” is explained. The “half-turn detection mode” is a mode for detecting, during execution of the application of the music player, the sub-display unit display application AP1, or the like explained above, a moving direction and a moving distance of touch operation in the sensor unit 120 in order to select an item displayed on the sub-display unit ELD.

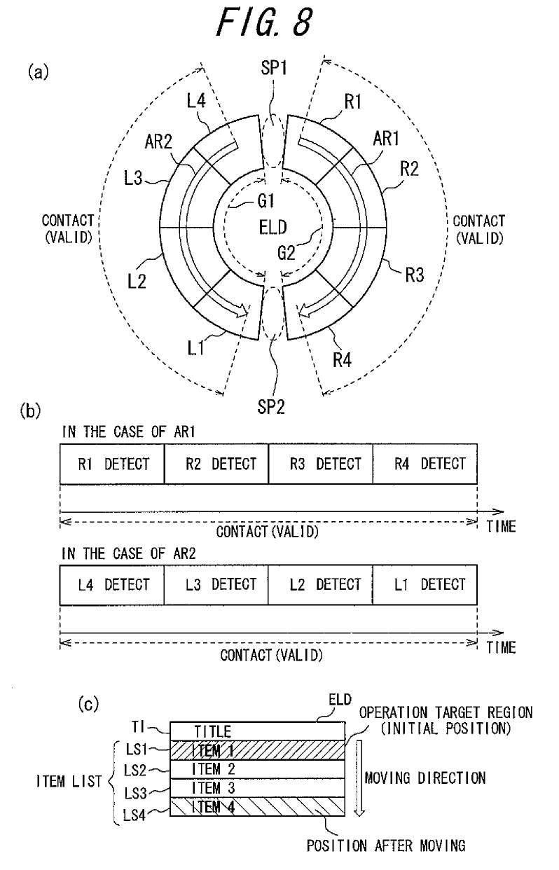

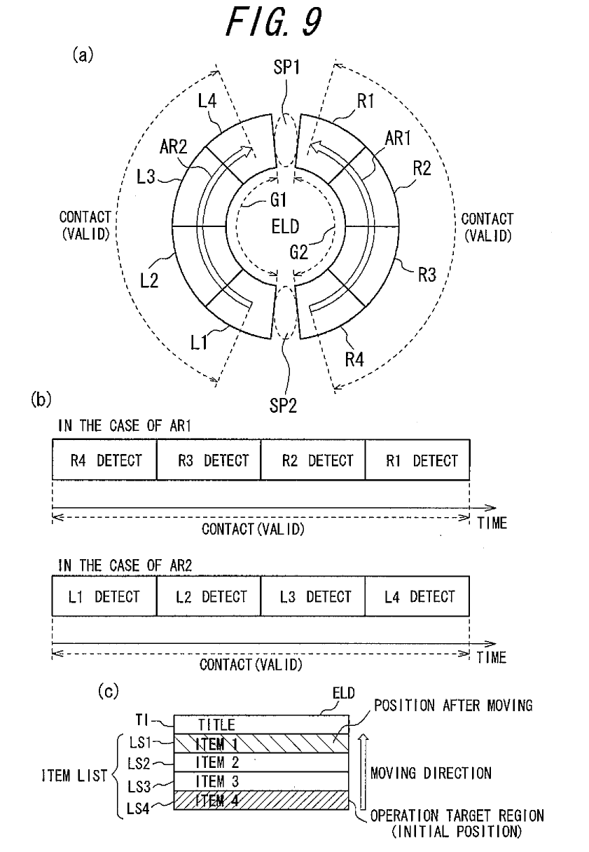

FIGS. 8 and 9 are diagrams for explaining an example of the “half-turn detection mode” and showing an operation of the sub-display unit in the case in which the user traces over the sensor elements. In FIGS. 8 and 9, (a) is a schematic diagram showing, for simplification of explanation, only the sub-display unit mounted on the cellular phone terminal and the sensor elements arranged side by side along the periphery of the sub-display unit, (b) is a diagram showing the sensor elements that perform sensing according to transition of time, and (c) is a diagram showing a positional change in an operation target area of the sub-display unit ELD corresponding to the sensor elements that perform sensing. In (a) of the figures, the sensor elements, the sensor element groups, and the separation sections are denoted by reference numerals and signs same as those in FIG. 2(b). In display of the sub-display unit ELD in (c), TI indicates a title of an item list displayed by the sub-display unit and LS1 to LS4 indicate selection candidate items (e.g., several rows that can be scrolled). In the sub-display unit in (c), a cursor is arranged on an item in a state of targets of operation or the item itself is highlighted by reversing display or the like such that the item can be identified as a present operation target area. In these figures, the item displayed as the operation target area is hatched to be highlighted. For convenience of explanation, a “moving target” is explained only in the operation target area. However, the sub-display unit operates in the same principle when the item itself is moved (scrolled).

When the user continuously traces over the respective sensor elements using touching means such as a finger in an up to down direction indicated by an arrow AR1 in FIG. 8(a), the control unit senses contact in the transition of time shown in (b). In this case, the sensor elements R1, R2, R3, and R4 sense contact in this order. The continuous contact from R1 to R4 is detected in two or more of the adjacent sensor elements. Therefore, the operation target area moves on the list displayed on the sub-display unit ELD according to the number of times a direction is detected and the adjacent sensor elements are shifted and the direction. In this case, as shown in (c), the operation target area moves by three items downward from the item LS1 to the item LS4 in an initial position. The operation target area is represented by the hatching. A position with a narrow hatching pitch is the initial position and a position with a wide hatching pitch is a position after the movement. In this case, according to this configuration, like a “downward indication operation of a finger” of the user, since the “operation target area moves downward” on the sub-display unit, the user feels as if the user freely moves the operation target area with the user's finger. In other words, operation sense as intended by the user is obtained.

Similarly, if the sensor elements are traced in a direction indicated by an arrow AR2 in (a) of the figure, the sensor elements L4, L3, L2, and L1 among the sensor elements sense contact in this order as shown in (b). In this case, like the contact indicated by the arrow AR1, since the contact is contact transitioning on the adjacent three sensor elements, the operation target area moves by three items from the item LS1 to the item LS4 downward as shown in (c).

If the sensor elements are traced in a down to up direction (the counterclockwise direction) indicated by the arrow AR1 in FIG. 9(a), the sensor elements R4, R3, R2, and R1 among the sensor elements sense contact in this order as shown in (b). In this case, since the contact is contact transitioning on the adjacent three sensor elements, the operation target area moves by three items from the item LS4 to the item LS1 upward as shown in (c).

Similarly, if the sensor elements are traced in a down to up direction (the clockwise direction) indicated by the arrow AR2 in (a) of the figure, the sensor elements L1, L2, L3, and L4 among the sensor elements sense contact in this order as shown in (b). In this case, since the contact is contact transitioning on the adjacent three sensor elements from down to up like that indicated by the arrow AR1, the operation target area moves by three items from the item LS4 to the item LS1 upward as shown in (c).

In this way, in the “half-turn mode”, in the respective sensor element groups, only contact with certain one sensor element (e.g., R2) is not detected as movement. Only when the contact transitions from the sensor element to a sensor element adjacent thereto (e.g., R3), the contact is detected as movement for one element (one item in the sub-display unit ELD) in the direction of the transition. Therefore, contact transition between adjacent two sensor elements over the separation section SP1 or SP2, i.e., contact transition between L4 and R1 and contact transition between L1 and R4 are determined as invalid and are not detected as movement.

Even in the contact transition over the separation section SP1 or SP2, if there is transition between adjacent sensor elements in the same sensor element group, contact transition in the sensor element group is determined as valid and detected as movement in the direction of the contact transition. Therefore, for example, when contact transitions R3→R4→L1, transition of R3→R4 is determined as valid and transition of R4→L1 is determined as invalid. The operation target area moves by one item downward in the sub-display unit ELD. When contact transitions clockwise from R1 to L4, transition from R1 to R4 is determined as valid, transition of R4→L1 is determined as invalid, and transition from L1 to L4 is determined as valid. The operation target area moves by three items downward in the sub-display unit ELD and, then, moves by three items upward and returns to the original position.

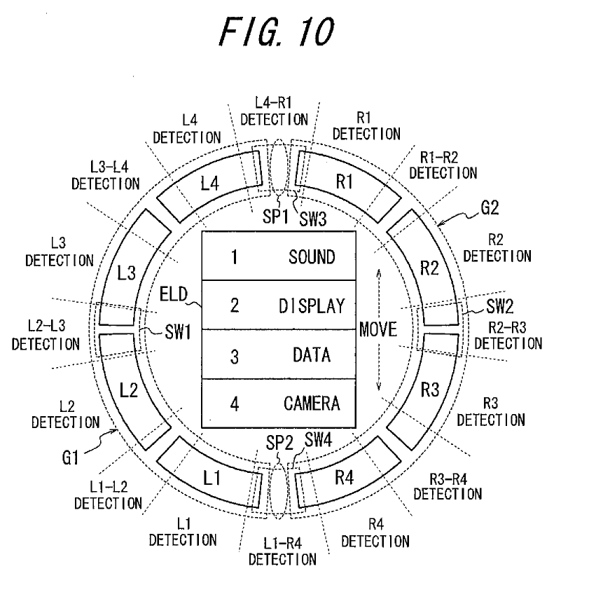

FIG. 10 is a conceptual diagram for explaining another example of the “half-turn detection mode”. In this example, in order to determine, as a sensor element detection state, not only a single element detection state but also a plural element detection state in which adjacent two elements are detected, a detection state is divided into sixteen detection states. A configuration explained below is substantially the same as the configuration shown in FIG. 5. However, a tact switch is also provided between the first sensor element group G1 and the second sensor element group G2, i.e., a tact switch SW3 is provided between the sensor element L4 and the sensor element R1 and a tact switch SW4 is provided between the sensor element R4 and the sensor element L1.

As shown in FIG. 10, the control unit 110 can manage, sixteen detection states in total including, besides R1 detection, R2 detection, R3 detection, R4 detection, L1 detection, L2 detection, L3 detection, and L4 detection in which only a single sensor element detects contact, R1-R2 detection, R2-R3 detection, R3-R4 detection, L1-R4 detection, L1-L2 detection, L2-L3 detection, L3-L4 detection, and L4-R1 detection in which contact of adjacent two sensor elements is detected. In other words, this “half-turn detection mode”, sensor element detection states are increased to sixteen, such that the single element detection state in which an operation state is detected for only one sensor element and an adjacent element detection state in which operation states of adjacent two sensor elements can be detected. This makes it possible to perform more precise control.

When the control unit 110 manages one detection state of each of the eight sensor elements, the control unit 110 can manage eight detection states. However, in the eight detection states, since the number of states, i.e., a state change is small, very precise control cannot be performed. In a portable electronic apparatus required to have portability, since a size itself of sensor elements is small, a finger may touch plural sensor elements. In that case, when contact is detected, for example, in order of the sensor elements L2 and L3, this is regarded as an upward movement instruction. It is likely that an operation unintended by the user is performed. In order to appropriately process such detection of contact with the sensor elements, it is necessary to reserve decision of a movement instruction until a change (movement) in two or three detection states are detected in the sixteen detection states. Processing for reserving decision of a movement instruction is explained in detail below with reference to a flowchart.

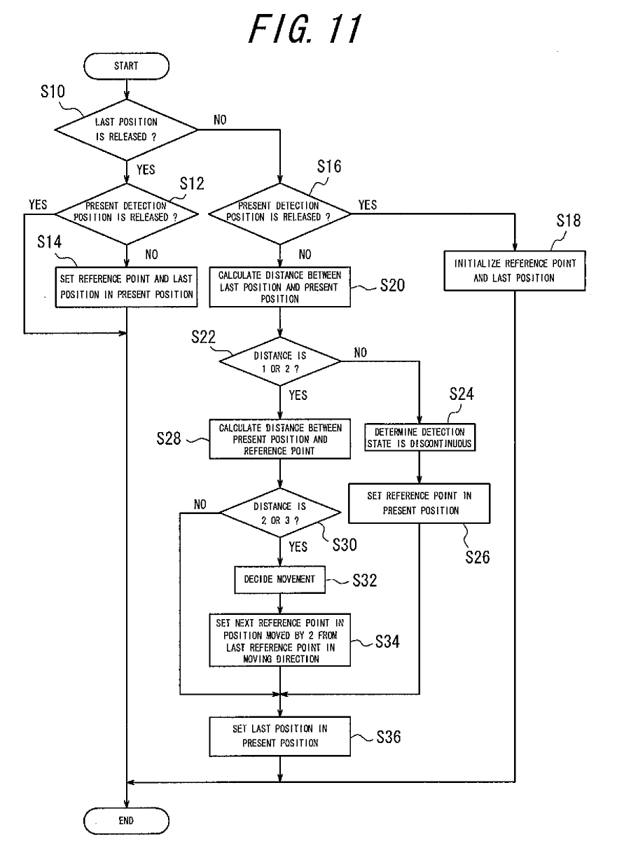

FIG. 11 is a flowchart showing an example of movement fixing processing (i.e., reservation processing) in the sixteen detection states. The touch sensor driver TSD performs the processing shown in this flowchart every time any one of the detection states occurs in the queue QUE. A first reference point is set in a position detected first in a released state (any one of the sixteen detection states). The touch sensor driver TSD determines a moving distance (transition of a detection state) from this reference point, a present detection position (a detection state input to the queue QUE anew), and the last detection position (an immediately preceding detection state left in the queue QUE). As shown in the figure, in step S10, the touch sensor driver TSD determines whether the last position is released. When it is determined that the last position is released (the last data left in the queue QUE is “release”), the touch sensor driver TSD proceeds to step S12 and determines whether the present detection position is released (i.e., data input anew is “release”). When it is determined that the present detection position is released, the touch sensor driver TSD finishes the processing. Otherwise, the touch sensor driver TSD proceeds to step S14 and sets the reference point and the last detection position in the present detection position.

When it is determined in step S10 that the last position is not released (i.e., other detection occurs and the present detection follows the detection), the touch sensor driver TSD proceeds to step S16 and determines whether the present detection position is released (i.e., a signal input anew is “release”). When it is determined that the present detection position is released, the touch sensor driver TSD initializes (clears) the reference position and the last detection position and finishes the processing (step S18). When it is determined in step S16 that the present detection position is not released, the touch sensor driver TSD calculates a distance between the last detection position and the present detection position (step S20) and determines whether the calculated distance is 1 or 2 (step S22). When it is determined that the calculated distance is not 1 or 2, the touch sensor driver TSD determines that the detection state is a discontinuous detection state in which sensor elements are skipped (step S24), sets the reference point in the present detection point and proceeds to step S36. When it is determined in step S22 that the calculated distance is 1 or 2, the touch sensor driver TSD calculates a distance between the present detection position and the reference point (step S28). Since a detection position of each of the sensor elements can be seen according to a signal input to the queue QUE, the touch sensor driver TSD performs the calculation of a distance by determining a distance in terms of the number of detection states among the sixteen detection state is present between the last detection position and the present detection position.

The touch sensor driver TSD determines whether the distance calculated in step S28 is 2 or 3 (step S30). When the condition is not satisfied (i.e., the distance is equal to or larger than 4), the touch sensor driver TSD proceeds to step S36 determining that an error occurs. When the condition is satisfied (the distance is 2 or 3), the touch sensor driver TSD decides movement (step S32). A position touched first is set as the “reference point” and, thereafter, the “last position” is updated when contact is continuously detected without being “released”. Finally, only when the “present position” as the latest detection position is determined as “moving 2 or 3” with respect to the reference point, the touch sensor driver TSD determines that “there is movement”. Further, the touch sensor driver TSD determines that the movement is “movement by 2” by continuously detecting the single element detection state and the plural element detection state. Therefore, on the sensor elements, the finger moves by one sensor element only when the movement is the “movement by 2”. The touch sensor driver TSD sets the next reference point in a position moved by 2 from the previous reference point in the moving direction (step S34) and proceeds to step S36. In step S36, for the next processing, the touch sensor driver TSD sets the “last detection position” in the “present detection position” and finishes the processing.

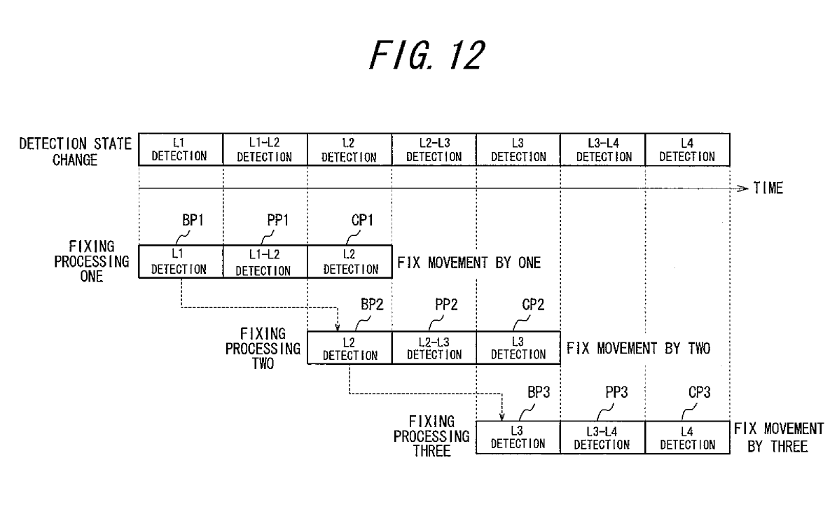

FIG. 12 is a diagram for explaining fixing processing in the case in which the processing of the flowchart shown in FIG. 11 is applied to contact with the sensor elements L1 to L4 shown in FIG. 10. As shown in the figure, a detection state change is a change in order of “L1 detection”, “L1-L2 detection”, “L2 detection”, “L2-L3 detection”, “L3 detection”, “L3-L4 detection”, and “L4 detection”. In other words, the single element detection state and the plural element detection state are repeatedly detected from L1 to L4. First, the touch sensor driver TSD sets the first “L1 detection” in a reference point BP1 (S14). Next, when the “L1-L2 detection” occurs, since the last position is not release but is the “L1 detection”, the touch sensor driver TSD compares the last position and the present position detected this time (S22). Since movement is movement by one frame from L1 to L1-L2 and satisfies the determination condition “1 or 2?”, the touch sensor driver TSD determines that the movement is valid and, then, compares the reference point and the present position (S30). Since the reference point and the last position are set in the same L1, a movement amount is still one frame. Movement is not decided at this stage. The touch sensor driver TSD sets an L1-L2 detection state in the present position as the last position PP1 (S36).

Further, when the “L2 detection” occurs without “release” occurring during the detection, since the last position is in the “L1-L2 detection”, the touch sensor driver TSD compares the last position and the present position CP1 detected this time (S22). Since movement is movement by one frame from L1-L2 to L2, the touch sensor driver TSD determines that the movement is valid because the movement is movement by one frame from L1-L2 to L2 and the determination condition “1 or 2?” is satisfied and compares the reference point and the present position (S30). Since the reference point is set in the same L1 without being changed from that during the L1 detection this time, a positional relation with L2 is two frames. Therefore, the touch sensor driver TSD determines that a movement amount is two frames. The movement is decided here for the first time (S32). For the next determination, the touch sensor driver TSD sets the reference point BP2 at a point transitions two frames from the “L1 detection” in the moving direction, i.e., the “L2 detection” (S34), sets the last position in the present position “L2 detection” again, and completes the fixing processing 1 (S36).

In this way, the touch sensor driver TSD detects the transition of the detection state by two frames to determine movement “1”. When the movement is decided in step S32, the touch sensor driver TSD stores a moving direction component (the clockwise direction from L1 to L4) and the movement of “1” in the result notifying unit NTF and notifies the base application BA of update of stored contents. The base application BA extracts this updated contents and notifies the sub-display unit display application AP1 or the like of the updated contents. If the sub-display unit display application AP1 is in use, since the movement amount of “1” is given in the “down to up direction” on the basis of the moving direction component, the touch sensor driver TSD changes the display of the sub-display unit ELD as processing corresponding to the movement amount. Specifically, when list display shown in FIG. 8(c) is performed and the operation target area is located in LS4, the operation target area moves to LS3 on the basis of the fixing processing 1. Like this fixing processing 1, when a detection state continuously transitions to “R4-R3 detection” and “R3 detection” from the “R4 detection” state with respect to R1 to R4 as the second sensor element group, the touch sensor driver TSD gives information concerning the “down to up direction” based on a moving direction component and the grant of the movement amount of “1” to the sub-display unit display application AP1 through the base application. On screen display of the list display, as in the operation in the first sensor element group, the operation target area changes from the item LS4 to the item LS3.

Next, in the following explanation, the movement of the finger continues without occurrence of “release” following the fixing processing 1. As in the case of the fixing processing 1, as indicated by fixing processing 2 in the figure, when the detection state proceeds by two frames from the reference point BP2, the “L2-L3 detection” is set in the last position PP2 and the “L3 detection” is set in the present position CP2, a distance between the reference point BP2 and the present position CP2 is two frames. Therefore, the movement “1” is further decided. In other words, total movement of “2” is decided by both the fixing processing 1 and the fixing processing 2 following the fixing processing 1. For further following processing, the “L3 detection” two frames ahead of the reference point BP2 “L2 detection” is set as a new reference point BP3 to change the reference point.

Similarly, as indicated by fixing processing 3 in the figure, when the detection state proceeds by two frames from the reference point BP3, the “L3-L4” detection” is set in the last position CP3 and the “L4 detection” is set in the present position CP3, a distance is two frames. Therefore, the movement “1” is further decided. The movement of “3” in total including those decided in the fixing processing 1 and the fixing processing 2 are decided. In this way, the movement of “3” in total is notified to the application.

As display in the sub-display unit ELD, following the fixing processing 1, movement decision of “1” in the “down to up direction” is notified to the sub-display unit display application AP1 twice. Therefore, the operation target area changes to LS1 moved by “2” in the upward direction from LS3. Regardless of the fact that not only the single element detection state but also the plural element detection state is detected to fragment the detection state, since a movement amount decided by the movement of the state transition two frames is set to “1”, eventually, maximum movement decision of “3” is performed in the case of the sensor elements including the four sensor elements in the example. In other words, finally, an apparent movement amount is extremely close to that obtained when movement decision is performed only by the single element detection in the case of four sensor elements. However, even if the user does not accurately touch only right above a single element, the maximum movement amount of “3” can be secured. Some reaction is made even to inaccurate operation by the user. It is possible to meet a desire of the user.

When the user carrying the cellular phone performs operation in a place where vibration tends to occur, it is likely that the finger separates from the sensor unit 120 for an instant because of external vibration during movement of the finger. In such a case, in a rough detection system for detecting movement by performing only the single element detection for performing detection only for the number of sensor elements, detection omission less easily occurs. However, in a precise detection system for sensing not only the single element detection state but also the plural element detection state, even if the finger separates from the sensor unit 120 only for an instant, since the finger continues rotation, it is likely that one detection state is skipped. However, since it is determined in step S22 whether “the distance between the last position and the present position is 1 or 2?”, when the finger moves by 2 from the last position, i.e., even if one detection state is skipped from the last position, the movement can be treated as a continuous movement detection state. Therefore, it is possible to bring the movement as close as possible to an operation desired by the user even under vibration.

Since not only the distance of two frames but also the distance of three frames is determined as valid in step S30, moving operation can be detected even when the finger comes off a moment because of vibration or the like or movement is detected with one detection state skipped in quick operation. Further, in detection of a moving amount for three frames, as in the detection of a movement amount for two frames, rather than simply deciding the movement amount of “1”, a reference point for the next detection is set to move only two frames with respect to the last reference point as in the movement by two frames. Therefore, even when movement decision by three-frame detection is performed, it is possible to secure an amount for deciding movement of “n−1” obtained by subtracting 1 from the number of sensor elements “n”. For the user, it is possible to obtain a stable sense of operation, i.e., the same sense of operation in whatever way the user touches the sensor elements.

In this way, the single element detection state in which an operation state is detected only for one of the plural sensor elements and the adjacent element detection state in which operation states of adjacent two sensor elements among the plural sensor elements are sensed and movement is determined according to a combination of the single element detection state and the adjacent element detection state. Consequently, a feeling of operation intended by the user is obtained and more precise movement detection can be performed without remodeling the apparatus. Further, a malfunction caused when the user simultaneously touches two different points can be prevented and misdetection caused when the user simply touches the sensor elements or due to the influence of noise or the like can also be prevented.

When five or more selection items are displayed on a screen and detection is performed only by four elements, in order to select a bottom stage of the selection items, the user has to trace from upper elements to lower elements with a finger several times. However, in this “half-turn detection mode”, for example, since a maximum movement amount of two frames is given by two elements, the number of times of tracing can be reduced. In other words, this can be diverted to provision of a large number of kinds of movement parameters with a small number of sensor elements.

Next, the “turn detection mode” is explained. The “turn detection mode” is a mode for detecting the number of turns and a turning direction of touch operation in the sensor unit 120, for example, when security lock is released, for example, during execution of the lock security application AP2.

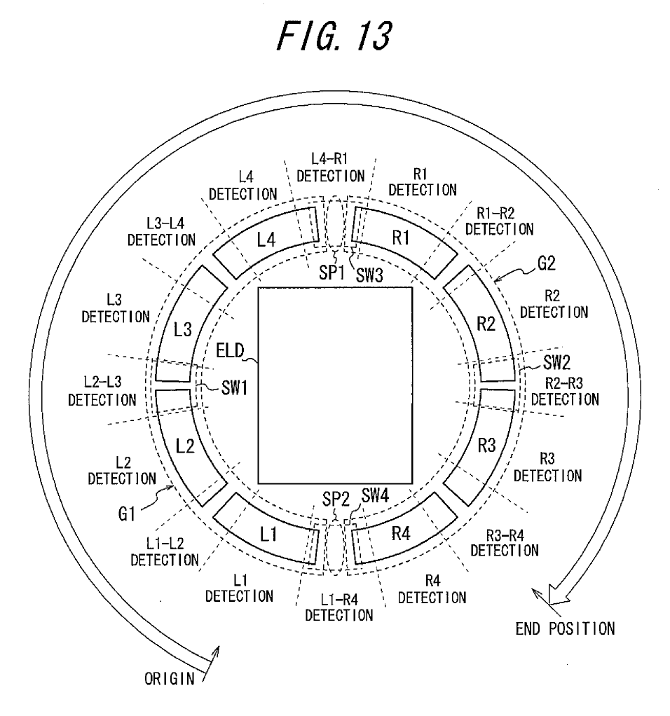

FIG. 13 is a diagram for explaining an example of the “turn detection mode”. Like FIG. 10, FIG. 13 is a conceptual diagram showing a sensor element detection state divided into sixteen detection states including the single element detection state and the plural element detection state. In this embodiment, the annularly-arranged sensor elements L1 to L4 and R1 to R4 are grasped as one sensor element group. It is sensed that one sensor element in this sensor element group detects contact and, with the position of the one sensor element set as an origin, plural sensor elements up to a position one sensor element before the origin clockwise from the origin continuously detect contact in order within a predetermined time (e.g., several seconds). In this way, touch operation in one clockwise turn is detected.

For example, in FIG. 13, when clockwise turn is detected, when a press position touched by a finger in a released state is an L1 detection position, with L1 set as an origin, it is sensed that contact is continuously detected in order from L1 up to a R3-R4 detection position including touch detection by the sensor element R4 one sensor element before L1 clockwise within a predetermined time. It is detected that touch operation of one clockwise turn is performed. Thereafter, without the finger being released, when contact is continuously detected in order within the predetermined time from L1 up to the R3-R4 detection position, it is detected that the next touch operation in one clockwise turn is performed. Thereafter, the same operation is repeated until the finger is released from the sensor element group.

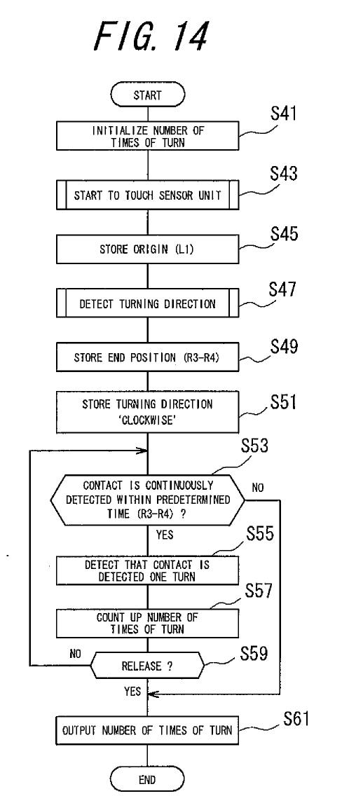

FIG. 14 is a diagram showing a flowchart in this case. First, when processing for releasing security lock is selected during execution of the lock security application AP2, the control unit 110 initializes the number of times of turn stored in the storage region 142 of the storing unit 140 shown in FIG. 1 (S41). Thereafter, when the user starts to touch the sensor unit 120 (S43), the control unit 110 stores a press position touched by the finger first in the storage region 142 as an origin (a start position) (S45). Assuming that the finger touches the L1 detection position first, the control unit 110 stores the position L1 as an origin.

Thereafter, the control unit 110 senses that turning operation by the user is started according to a change in a contact signal read out from the queue QUE and detects a transitioning direction of contact, i.e., a turning direction (S47). The control unit 110 determines a position, which is one sensor element before the origin position as an end point of one turn detection, as an end position from the detected turning direction and the origin stored in step S45 and stores the position in the storage region 142 (S49). In this example, since the origin is L1 and the turning direction is clockwise, the R3-R4 detection position including a contact detection position by the sensor element R4 one sensor element before the sensor element L1 clockwise is determined as the end position R4 and stored.

Thereafter, in a state in which the turning direction in the turn detection processing is held clockwise (S51), the control unit 110 detects, on the basis of a sequential change in a contact signal read out from the queue QUE, the sensor elements continuously detect contact in order from the origin L1 up to the R3-R4 detection position including the clockwise end position R4 within a predetermined time (S53). When contact is detected in order, the control unit 110 detects that contact is detected one turn clockwise (S55) and counts up a number of turns counter (S57). Thereafter, the control unit 110 determines on the basis of the contact signal whether the finger is released (S59). When the finger is not released, the control unit 110 shifts to step S53 and detects the next clockwise turn with the same position L1 set as an origin.

On the other hand, when it is detected in step S53 that the sensor elements do not continuously detect contact in order from the origin L1 up to the R3-R4 detection position including the clockwise end position R4 within the predetermined time or when it is determined in step S59 that the finger is released, the control unit 110 outputs a count value in the number of times counter at that point (S61) and finishes the turn detection processing.

In this way, in this embodiment, in the “turn detection mode”, when one sensor element (e.g., L1) of the annularly-arranged sensor elements L1 to L4 and R1 to R4 detects contact, with the position of the one sensor element set as an origin, the control unit 110 senses that plural sensor elements up to a position (e.g., R3-R4) including a detection position by a sensor element one sensor element before the origin clockwise continuously detect contact in order within a predetermined time and detects clockwise one turn. Therefore, it is also possible to perform processing for, for example, release security lock using a lock security application of an accounting service employing an RFID.

Concerning detection in second and subsequent turns in the same direction, since the origin is not changed, a sense of discomfort is not given to the user. If the origin is set in a detection completion position in the first turn, detection in the second turn is performed in a position further before the detection completion position. When detection is continued in the third and fourth turns, a detection position gradually shifts backward in the origin direction. Finally, it is likely that detection for ten turns can be performed in nine turns. A sense of discomfort is given to the user. In this embodiment, in order to prevent such a problem from occurring, the origin at the time of the start of the first turn is maintained as detection start positions in the respective turns.

Further, in the case of turning operation, from the user side, unlike movement of the cursor, even in quick operation, the user only has to move the finger turn by tracing the sensor element groups with the finger. Therefore, rough operation tends to be performed. Therefore, even if the user correctly memorizes a start position (a press position), it is anticipated that operability falls, for example, the finger is not accurately moved turn and tends to be released from the senor element group before the start position, the turning operation is not sensed, the user is forced to retry the operation many times, and a sense of discomfort is given to the user. In this embodiment, a range from the start position up to the detection position by the sensor element one sensor element before the start position in the turning direction is sensed as one turn. Therefore, even when the user does not correctly memorize the start position and roughly performs the turning operation clockwise, it is possible to surely sense the turning operation. Therefore, it is possible to improve operability and prevent such a sense of discomfort as to forcing the user to retry the operation many times from being given to the user.

In the above explanation, the turning direction is clockwise. However, the same applies in the case of counterclockwise. The end position of turn is not limited to the position one sensor element before the origin in the turning direction and can be a position two or more sensor elements before the origin. For example, as the press position touched by the finger first, in the case of the L1-L2 detection position, one of the positions may be determined to be set as the origin in advance or the origin once determined may be changed according to the turning direction. For example, in the case of L1-L2 detection position, the origin is determined as L1 and, thereafter, when the turning direction is detected as clockwise, the origin is kept in L1 and the end position is determined as R4 when the end position is a position one sensor element before the origin. When the turning direction is detected as counterclockwise, the origin is changed from L1 to L2 and the end position is determined as L3 when the end position is a position one sensor element before the origin. Consequently, even if first contact occurs in the plural element detection state, the origin can be surely set and a predetermined number of counts is easily performed because the counts can be performed in sensor element units. Moreover, the end positions can be set in positions the same number of sensor elements before the origin in both the turning directions. Therefore, even if first contact occurs in the plural element detection state, the user can obtain the same operability regardless of whichever direction the turning direction is and does not feel uneasiness.

Furthermore, in this embodiment, the sixteen sensor element detection states including the plural element detection state in which the adjacent two sensor elements simultaneously detect contact are monitored to detect turn. However, eight sensor element detection states in which only a single senor element detects contact can be monitored to detect turn.

Next, processing by the touch sensor module TSM and the sub-display unit ELD at the time when the casing of the cellular phone terminal 100 transitions from the opened state to the closed state is explained according to the elapse of time.

First, when the closed state occurs, power supply to the touch sensor module TSM is started. When an electrostatic capacitance touch sensor is used, the touch sensor module TSM needs some time for calibration. Since the touch sensor cannot be used during such calibration, even if the sub-display unit ELD performs display of selection items or the like, operation by the touch sensor cannot be performed and the user feels a sense of discomfort. In order to solve this problem, power supply to the sub-display unit ELD is started being delayed a little from the start of the power supply to the touch sensor module TSM. Rendering is started after completion of the calibration of the touch sensor. In other words, before completion of display by the sub-display unit ELD, a period in which the calibration of the touch sensor is already completed could occur. When processing for changing the display by the sub-display unit ELD is performed when operation by the touch sensor is performed, for the user who operates the touch sensor in order to perform detection for one turn, there is a problem in that, if an origin is set regardless of the fact that a change does not occur on the display, the user does not see to which sensor element the user should trace to perform the detection for one turn.

Therefore, in this embodiment, it is preferable that, even if contact detection by the touch sensor occurs, an origin for turn detection is not set until display by the sub-display unit ELD is completed and, after the sub-display unit ELD becomes a displayable state, the origin is set and, at the same time, display involved in the contact detection is performed. Consequently, the user can easily grasp the position of the origin during turning operation.

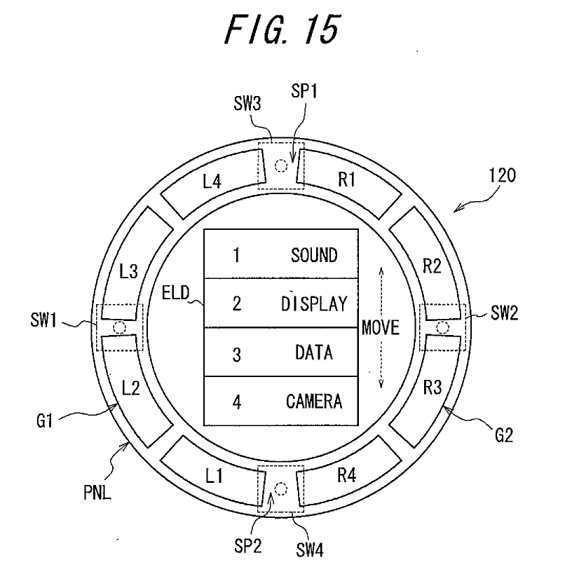

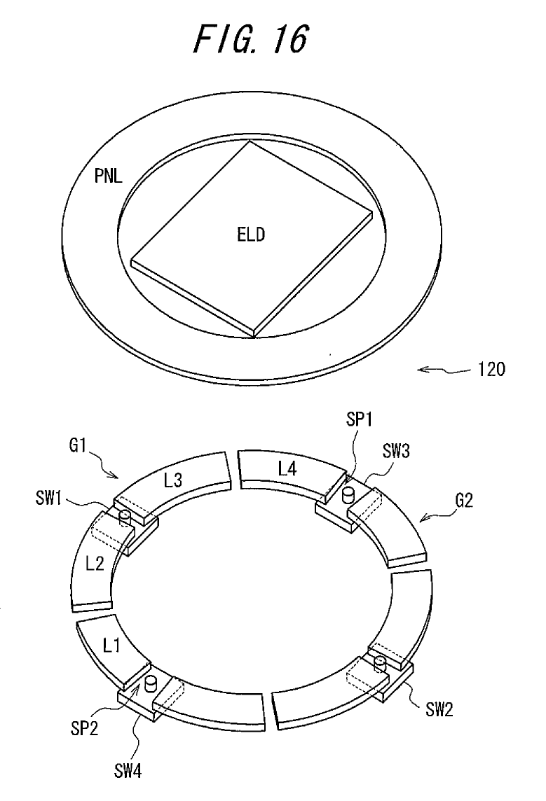

(Second Embodiment) FIGS. 15 and 16 are diagrams showing a configuration of a main UNIT of a cellular phone terminal according to a second embodiment of the present invention. This embodiment is different from the first embodiment in a configuration of the sensor unit 120. FIG. 15 is a plan view showing the arrangement of components of the sensor unit 120 and the sub-display unit ELD. FIG. 16 is a disassembled perspective view of the sensor unit 120. In this embodiment, the tact switches SW3 and SW4 are respectively provided between the sensor element L4 and the sensor element R1 and between the sensor element R4 and the sensor element L1, which are between the first sensor element group G1 and the second sensor element group G2. Like the tact switches SW1 and SW2, the tact switches SW3 and SW4 are arranged in the third layer located below the second layer in which the sensor elements L1 to L4 and R1 to R4 are arranged. The other components are the same as those in the first embodiment.

Since the tact switches SW3 and SW4 as electronic components other than the sensor elements are arranged between the first sensor element group G1 and the second sensor element group G2 in this way, it is possible to realize effective use of a space and contribute a reduction in size of the entire apparatus. The tact switch SW3 can be used as, for example, a switch for executing the sub-display unit display application AP1 and a switch for moving a selection target area displayed on the sub-display unit ELD upward by one item. The tact switch SW4 can be used as, for example, a cancel key and a switch for moving the selection target area displayed on the sub-display unit ELD downward by one item.

In this embodiment, the panel PNL has flexibility sufficient for depressing the tact switches SW1 to SW4 or is attached to an apparatus casing to be slightly tiltable and has a role of a plunger for the tact switches SW1 and SW4.

FIG. 16 is a disassembled perspective view of components, in particular, the sensor unit 120 of the cellular phone terminal 100 shown in FIGS. 2 and 15. As shown in the figure, the panel PNL and the sub-display unit ELD are arranged in a first layer forming an outer surface of a terminal casing. The sensor elements L1 to L4 and R1 to R4 are arranged in a second layer located below the panel PNL in the first layer. The tact switches SW1, SW2, SW3, and SW4 are respectively arranged in a third layer located below a space between the sensor elements L2 and L3 in the second layer, below a space between the sensor elements R2 and R3, below a space between the sensor elements L4 and R1, and below a space between the sensor elements R4 and L1.

The cellular phone terminal according to this embodiment can be caused to operate in the same manner as the first embodiment concerning the “half-turn detection mode”. Therefore, explanation concerning the “half-turn detection mode” is omitted. The “turn detection mode” is explained with reference to the configuration of the first embodiment.

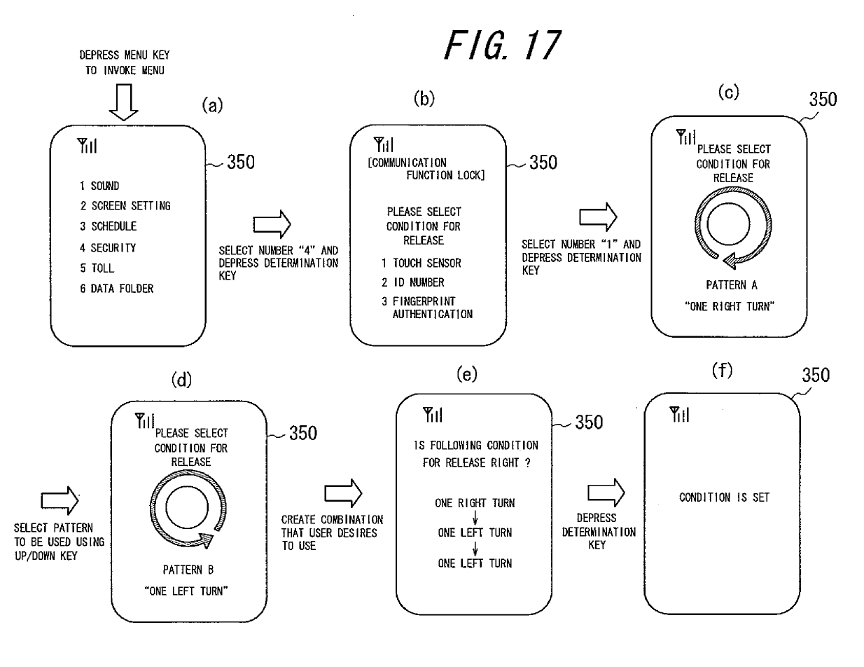

FIG. 17 is a diagram showing an example of release condition setting for a communication function lock by the lock security application AP2. A screen for setting conditions for releasing a communication function lock is displayed on a main display unit 350 provided in a position where the cellular phone terminal 100 is exposed in the opened state. A user sets release conditions by operating the key operation unit KEY according to the display screen. For this purpose, first, the user depresses a menu key of the key operation unit KEY to cause the main display unit 350 to display a menu screen as shown in FIG. 17(a). The user selects a relevant display item, i.e., “4” from the menu display screen and depresses a determination key to display, for example, an operation item for releasing a communication function lock shown in FIG. 17(b). Since the communication function lock is released by operation of the sensor unit 120, i.e., the touch sensor, the user selects “1” from the display screen in FIG. 17(b) and depresses the determination key.

Thereafter, the user appropriately selects, with operation of an up/down key and the determination key of the key operation unit KEY, a turn pattern including a forward and reverse turn in which a right turn (clockwise) and a left turn (counterclockwise) shown in FIGS. 17(c) and 17(d) are continuous, creates a release condition as a combination of turn patterns desired to be used for communication function unlock shown in FIG. 17(e). When a desired release condition is created, the user depresses the determination key to thereby display a message “condition is set” on the main display unit 350 as shown in FIG. 17(f) and finishes release condition setting operation for the communication function lock. As the release condition, as shown in FIG. 17(e), perform right turn once→perform left turn once→perform left turn once is set.

In FIG. 17, the release condition for the communication function lock is set by using the main display unit 350 and the key operation unit KEY. However, the same setting operation can be performed by the “half-turn detection mode” using the sub-display unit ELD and the sensor unit 120.

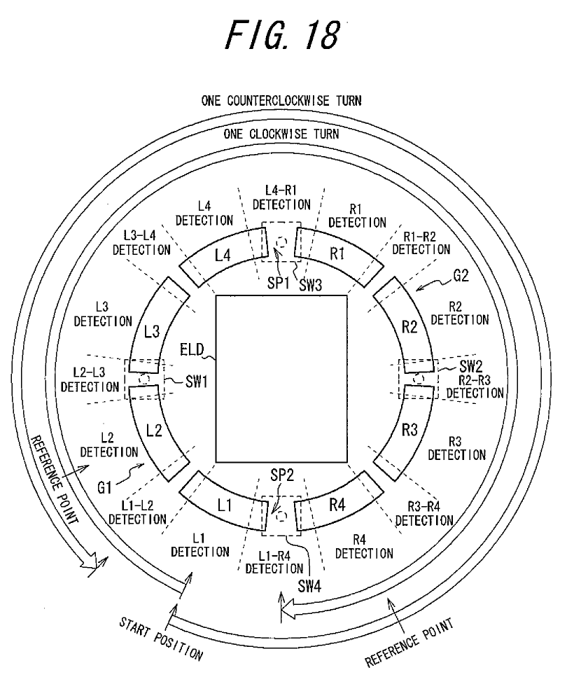

FIG. 18 is a diagram for explaining an example of detection of one turn in the “turn detection mode”. Like FIG. 10, FIG. 18 is a conceptual diagram showing a sensor element detection state divided into sixteen detection states including the single element detection state and the plural element detection state. In this embodiment, the annularly-arranged sensor elements L1 to L4 and R1 to R4 are grasped as one sensor element group. The position of one sensor element that detects contact in this sensor element group is set as a start position. The position of a sensor element that detects the next contact, a turning direction of which is detected from the start position, is set as a reference point. It is sensed that plural sensor elements continuously detect contact in order from the reference point up to the start position in the detected turning direction and one turn in the turning direction is detected.

For example, in FIG. 18, when a press position touched by a finger in a released state is an L1 detection position, L1 is set as a clockwise or counterclockwise start position (an origin). When an L1-L2 position including contact detection by the sensor element L2 is detected next from the start position, the sensor element L2 is set as a reference point. When contact is continuously detected clockwise in order from the reference point up to an L1-R4 detection position including contact detection by the sensor element L1, it is detected that clockwise one turn is performed. When the L1-R4 position including contact detection by the sensor element R4 is detected next from the start position, the sensor element R4 is set as a reference point. When contact is continuously detected counterclockwise in order from the reference point up to an L1-L2 detection position including contact detection by the sensor element L1, it is detected that counterclockwise one turn is performed. The touch sensor driver TSD determines a moving direction from a difference between the start position and the reference point as the sensor element position detected next and stores the moving direction together with the start position to thereby determine whether detection of following movement is detection in the same direction.

When a press position touched by the finger first in the released state is a plural element detection position, a turning direction can be detected according to transition to the next single element detection state. Therefore, for example, a position of a sensor element on a front side is set as a start position according to the turning direction. Therefore, for example, when the first press position is the L1-L2 detection position, L1 is set as a clockwise start position and L2 is set as a counterclockwise start position.

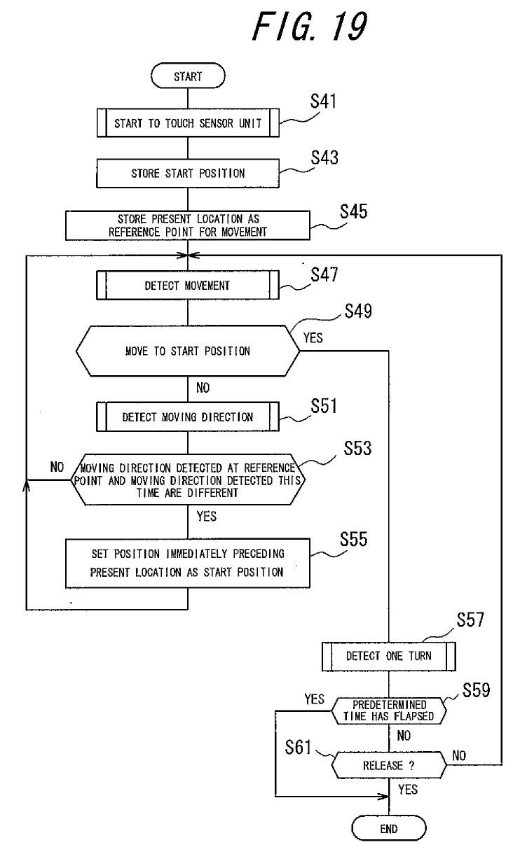

FIG. 19 is a diagram showing a flowchart of processing by the touch sensor driver TSD in this case. First, during execution of the lock security application AP2, for example, release processing for security lock for allowing/disallowing an accounting service employing an RFID is selected and the user starts to touch the sensor unit 120 (S41). The control unit 110 starts time counting, calculates a start position in clockwise and counter clockwise turn detection on the basis of a detection result of the press position touched by the finger first, and stores the start position in the storage region 142 of the storing unit 140 shown in FIG. 1 (S43). Assuming that the L1 detection position is touched first, the control unit 110 stores the position L1 as the start position in the clockwise and counterclockwise turn detection.

Thereafter, when the control unit 110 detects first, from a change in a contact signal read out from the queue QUE, that turning operation by the user is started, the control unit 110 stores a contact detection position at a point of detection (at present) (a present location) in the storage region 142 as a reference point of movement (for specifying a turning direction) (S45). Therefore, if the start position is L1 and L2 as the present position is stored as the reference point, the control unit 110 determines the turning direction as a “clockwise” direction. If R4 is stored as the reference point, the control unit 110 determines the turning direction as a “counterclockwise” direction.

When the reference point is stored, every time a change occurs in the contact signal read out from the queue QUE and movement of the contact position is detected (S47), the control unit 110 determines whether a present contact detection position involved in this movement reaches the start position (the origin) (S49). When the present contact detection position does not reach the start position (the origin), the control unit 110 specifies a moving direction on the basis of a difference between a position detected just before the present position and the present position (S51). The control unit 110 determines whether this moving direction is different from the moving direction stored at the stage of step S45 (S53). When the moving directions are the same, assuming that the contact detection is continuous movement detection in the same turning direction, the control unit 110 shifts to step S47 and continues to perform the movement determination. When the moving directions are not the same, the control unit 110 changes and updates contents of the stored moving direction with the moving direction specified anew this time and updates stored contents in the storage region 142 using a contact detection position just before the present position as a new start position (origin). In other words, when a rotating direction is reversed during the turning operation, the control unit 110 sets a position where reversal is started as an origin.

On the other hand, when it is determined in step S49 that the present contact detection position moves to the start position (the origin), the control unit 110 detects the movement as clockwise or counterclockwise one turn at that point (S57). The control unit 110 specifies, on the basis of the moving direction stored in the storage region 142, whether the turn is clockwise or counterclockwise and stores the detection of one turn in the specified moving direction in the storage region 142. If there is other turn detection, the control unit 110 updates stored contents to add the one turn detection to the turn detection. Thereafter, the control unit 110 determines whether a predetermined time (e.g., several seconds) has elapsed (S59), When the predetermined time has not elapsed, the control unit 110 further determines, on the basis of a contact signal, whether the finger is released (S61). When the finger is not released, the control unit 110 shifts to step S47 and detects the next turn. On the other hand, when it is determined in step S59 that the predetermined time has elapsed or when it is determined in step S61 that the finger is released, the control unit 110 finishes the turn detection mode at that point.

Finally, the touch sensor driver TSD notifies, via the base application BA, a running application program such as the security lock application of the number of times of turn in each of the moving directions stored in the storage region 142. The application program notified on the notified side performs processing corresponding to the number of times of turn in each of the moving directions. For example, when the security lock application is running and the number of times of turn in each of the moving directions is notified to the security lock application during lock release processing, the security lock application determines whether the number of times of turn coincides with the lock release condition set as explained above. When the number of times of turn coincides with the lock release condition, the security lock application releases security lock, starts processing for staring the RFID module RFID, and transitions to a state in which communication to the accounting service can be performed. The security lock application causes the sub-display unit ELD to display whether the lock release condition is satisfied.

At a stage when the predetermined time elapses from the first contact start (press start), even if contact detection occurs, the lock release processing for the security lock application may forcibly not be accepted on the assumption that “predetermined turning operation is not performed within the predetermined time”. When the next movement detection does not occur within a predetermined time after moving detection occurs, the detection of turning operation may be finished. Since only operation within a certain degree of a time frame is treated as a series of turning operation, it is possible to realize prevention of malfunction and improvement of security.

In this way, in this embodiment, in the “turn detection mode”, when one sensor element (e.g., L1) of the annularly-arranged sensor elements L1 to L4 and R1 to R4 detects contact, with the position of the one sensor element L1 set as a start position, the control unit 110 specifies a turning direction from the start position with the position of the sensor element (L2 or R4) where the next contact is detected set as a reference point. The control unit 110 senses that the plural sensor elements continuously detect contact in order from the start position up to the start position in the detected turning direction and detects one turn in the turning direction. When a change in the turning direction is detected on the basis of a sequential change in a contact signal, the control unit 110 detects one turn in the turning direction with a contact detection position at the present point set as a reference point in the turning direction and with an immediately preceding contact detection position set as a start position. Therefore, it is possible to surely detect a predetermined turn including a forward and reverse turn and release security lock. In other words, an origin position is updated when reversal occurs. Therefore, regardless of the fact that the user performs a rotating operation in a certain direction, when rotating operation in a reversed direction is started during the rotating operation, one turn detection can be performed by surely performing detection one turn in response to this reversal. Since the user can intuitively understand to a certain extent whether the user's finger has moved one turn. Therefore, the user can perform the turning operation without memorizing a position on an external appearance of the casing.

In this embodiment, the sixteen sensor element detection states including the plural element detection state in which the adjacent two sensor elements simultaneously detect contact are monitored to detect turn. However, eight sensor element detection states in which only a single sensor element detects contact can be monitored to detect turn.

Moreover, when rotation detection in plural forward and reverse direction is performed, although a rotation amount required for one turn detection for the rotation detection in each of the forward and reverse directions is vague, an origin position may not be changed even if reversal occurs. In steps S53 and S55 in FIG. 19, this is realized by not updating the origin position even if reversal is detected and keeping a first-pressed position as the origin. In this case, since the origin position is clear for the user, even when a large number of times of rotation detection is required, it is easy to visually recognize a movement amount required for rotation detection for each turn. Therefore it is possible to reduce operation mistakes.

When, following a first direction turn, a second direction turn opposite to the first direction turn is detected and a third direction turn is further detected, if a direction is switched from the second direction to the first direction, a position where the direction is switched is adopted as an origin in the third direction turn and, if a turn is performed in the second direction continuously from the second direction turn, an origin position in the second direction turn is adopted. This makes it possible to surely detect one turn of each of the turns naturally for the user.

The present invention is not limited to the embodiments and can be variously changed without departing from the spirit of the invention. For example, the control based on predetermining turning operation including a forward and reverse turn can be applied not only to release of security lock but also to various applications. The second embodiment is suitable for operation that requires accuracy such as locking. However, when speediness is required, rather than strictly detecting every turn, it is also conceivable to adopt a method of use for setting a turn as a predetermine turn according to how many times conversion itself of a rotating direction between a forward direction and a reverse direction of rotating operation is performed. This can be realized by counting the number of times of reversal detection in step S53 in FIG. 19 and notifying the application side of the number of times of reversal detection.

In the first embodiment, with the position of one sensor element set as an origin, a range from the origin up to a position a predetermined number of sensor elements before the origin in a predetermined turning direction is detected as one turn. However, it is also possible to detect, with the position of one sensor element set as an origin, a range from the origin up to the origin in a predetermined turning direction as one turn. In this case, for example, as explained in the first embodiment, when the sixteen sensor element detection states including the plural element detection state are monitored to detect a turn, if one sensor element (e.g., L1) detects contact, it is possible to sense that plural sensor elements continuously detect, with the position of the one sensor element set as an origin, contact in order from the origin up to, for example, a position (e.g., L1-R4) including a detection position by the one sensor element clockwise and detect a clockwise turn. Concerning the origin, as in the first embodiment, when a press position touched by the finger first is, for example, the L1-L2 detection position, one of the positions may be determined in advance to be set as an origin or an origin once determined may be changed according to a turning direction. For example, in the case of the L1-L2 detection position, it is also possible to determine an origin as L1 and, thereafter, when a turning direction is detected as clockwise, keep the origin in L1 and determine an end position as a position (L1-R4) including L1, and, when the turning direction is detected as counterclockwise, change the origin from L1 to L2 and determine the end position as a position (L2-L3) including L2. It goes without saying that, even in this case, it is also possible to monitor the eight sensor element detection states in which only a single sensor element detects contact and detect a turn.

In the present invention, the shape of the plural sensor elements is not limited to a substantial annular shape and can be arranged in an arbitrary pattern as long as the sensor elements have an annular shape such as a rectangular shape and a polygonal shape. The number of the sensor elements is not limited to eight and can be set to an arbitrary plural number. The plural sensor elements do not have to be a donut shape hollow in the center as long as the sensor elements are annularly arranged. Further, a sensor element is not limited to the contact sensor of the electrostatic capacitance type and the thin-film resistance type. Sensor elements of an optical system for sensing contact according to fluctuation in a light reception amount, an SAW system for sensing contact according to attenuation of a surface acoustic wave, and an electromagnetic induction system for sensing contact according to occurrence of an induction current can also be used. Depending on a type of a contact sensor, pointing apparatuses such as a dedicated pen other than a finger can also be used. The present invention can be applied not only to the cellular phone terminal but also widely to portable electronic apparatuses such as a PDA (personal digital assistant), a portable game machine, a portable audio player, a portable video player, a portable electronic dictionary, and a portable electronic book viewer.

### INDUSTRIAL APPLICABILITY

According to the present invention, in a portable electronic apparatus mounted with plural sensor elements that are annularly arranged side by side and detect contact, it is possible to a new operation method of simple and sure turning operation by sensing that one sensor element detects contact and then plural sensor elements continuously detect contact in order in a predetermined turning direction and detecting contact operation in one turn.

Further, according to the present invention, in a portable electronic apparatus mounted with plural sensor elements that are annularly arranged side by side and detect contact, a predetermined turn including a forward and reverse turn in which a first direction turn, in which the plural sensor elements continuously detect contact in order in the first turning direction, and a second direction turn, in which the plural sensor elements continuously detect contact in order in the second direction opposite to the first turning direction, are continuous is detected to make predetermined control executable. Therefore, it is possible to easily cope with various applications and improve universality.

1. A portable electronic apparatus comprising:
plural sensor elements that are annularly arranged and contact with which is detected; and
a control unit that monitors outputs of the plural sensor elements and executes control based on a change in the sensor elements, contact with which is detected, characterized in that
the control unit detects one turn of touch operation when contact is detected in one sensor element in the plural sensor elements and, with a position of the one sensor element set as an origin, contact is detected in plural sensor elements in a predetermined turning direction from the origin, and contact is continuously detected up to a sensor element in a position a predetermined number of sensor elements before the origin.

2. The portable electronic apparatus according to claim 1, characterized in that the control unit detects a next turn of touch operation when, after the one turn of touch operation is detected, contact is continuously detected in the predetermined turning direction through the origin in order up to the plural sensor elements to the position the predetermined number of sensor elements before the origin through the origin.

3. The portable electronic apparatus according to claim 2, characterized in that the control unit sets the origin in detecting a next turn of touch operation in a position of the one sensor element.

4. The portable electronic apparatus according to claim 1, characterized in that the control unit can sense, for each of the plural sensor elements, a single element detection state in which contact is detected only in a single sensor element and a plural element detection state in which contact is detected in all plural sensor elements adjacent to one another and sets, when a plural element contact state by the one sensor element and another sensor element adjacent to the one sensor element in the predetermined turning direction is sensed, a position of the one sensor element as the origin.

5. The portable electronic apparatus according to claim 4, characterized in that the control unit senses a detection state of plural elements including the sensor element in the position the predetermined number of sensor elements before the origin and a sensor element adjacent to the sensor element and further in a front in the turning direction and detects the one turn of touch operation.

6. The portable electronic apparatus according to claim 1, characterized in that the position the predetermined number of sensor elements before the origin is a position one sensor element before the origin in the turning direction.

7. A portable electronic apparatus comprising:
plural sensor elements that are annularly arranged and contact with which is detected; and
a control unit that monitors outputs of the plural sensor elements and executes control based on a change in the sensor elements, contact with which is detected, characterized in that
the control unit detects one turn of touch operation when contact is detected in one sensor element in the plural sensor elements and, with a position of the one sensor element set as an origin, contact is continuously detected up to the sensor element in the position of the origin from the origin in a predetermined turning direction.

8. The portable electronic apparatus according to claim 7, characterized in that the control unit detects a next turn of touch operation when, after the one turn of touch operation is detected, contact is further continuously detected in plural sensor elements in order up to the position of the origin through the origin in the predetermined turning direction.

9. The portable electronic apparatus according to claim 7, characterized in that the control unit can sense, for each of the plural sensor elements, a single element detection state in which contact is detected only in a single sensor element and a plural element detection state in which contact is detected in all plural sensor elements adjacent to one another and sets, when a plural element contact state by the one sensor element and another sensor element adjacent to the one sensor element in the predetermined turning direction is sensed, a position of the one sensor element as the origin.

10. The portable electronic apparatus according to claim 1, characterized in that the control unit detects the one turn of touch operation within a predetermined time after contact as the origin is detected.

11. The portable electronic apparatus according to claim 1, further comprising a display unit, display contents on which are changed by the control unit according to detection results of the plural sensor elements, characterized in that
the control unit detects touch operation of the one sensor element on condition that display by the display unit is performed.

12. An operation detecting method for a portable electronic apparatus characterized by comprising: monitoring outputs of plural sensor elements that are annularly arranged in a portable electronic apparatus and contact with which is detected; and detecting one turn of touch operation when contact is detected in one sensor element in the plural sensor elements and, with a position of the one sensor element set as an origin, contact is continuously detected in plural sensor elements up to a position a predetermined number of sensor elements before the origin in a predetermined turning direction up to the origin or from the origin.

13. A portable electronic apparatus comprising:
plural sensor elements that are annularly arranged and contact with which is detected; and
a control unit that monitors outputs of the plural sensor elements and executes control based on a change in the sensor elements, contact with which is detected, characterized in that
the control unit detects a predetermined turn including a forward and reverse turn in which a first direction turn and a second direction turn are continuous, the plural sensor elements continuously detecting contact in order in the first turning direction in the first direction turn and continuously detecting contact in order in the second direction opposite to the first turning direction in the second direction turn, and makes predetermined control executable.

14. The portable electronic apparatus according to claim 13, characterized in that the control unit detects the predetermined turn within a predetermined time after contact is detected in one sensor element in the plural sensor elements and executes the predetermined control.

15. The portable electronic apparatus according to claim 13, characterized in that the control unit sets an origin in detecting one turn in the first direction turn and an origin in detecting one turn in the second direction turn the same and detects the forward and reverse turn.

16. The portable electronic apparatus according to claim 15, characterized in that the control unit can further continuously detect, as the predetermined turn, after detecting a forward and reverse turn continuous from one turn in the first direction turn to one turn in the second direction turn, one turn in the first direction turn from the origin.

17. The portable electronic apparatus according to claim 15, characterized in that the control unit can further continuously detect, as the predetermined turn, after detecting a forward and reverse turn continuous from one turn in the first direction turn to one turn in the second direction turn, one turn in the second direction turn from the origin.

18. The portable electronic apparatus according to claim 13, characterized in that the control unit sets an origin in detecting one turn in the second direction turn in a position changed from the first direction turn to the second direction turn.

19. The portable electronic apparatus according to claim 18, characterized in that the control unit sets, in further continuously detecting the first direction turn as the predetermined turn after detecting a forward and reverse turn continuous from one turn in the first direction turn to one turn in the second direction turn, an origin of the detection in a position changed from the second direction turn to the first direction turn.

20. The portable electronic apparatus according to claim 18, characterized in that the control unit can detect, in further continuously detecting the second direction turn as the predetermined turn after detecting a forward and reverse turn continuous from one turn in the first direction turn to one turn in the second direction turn, one turn in the second direction turn from the origin.

21. The portable electronic apparatus according to claim 13, characterized in that the control unit determines the first turning direction or the second turning direction on the basis of a temporal change in outputs of the plural sensor elements and determines the first direction turn and the second direction turn in which contact in the first turning direction or the second turning direction is continuous.

22. The portable electronic apparatus according to claim 13, further comprising: a display unit; an operation unit; and a storing unit, characterized in that
the control unit causes, according to predetermined operation by the operation unit, the display unit to display a screen for setting a turning direction and the number of times of turn in the plural sensor elements and causes, when conditions are set by the operation unit or the plural sensor elements on the screen, the storing unit to store the conditions as conditions for executing the predetermined control.

23. A control method for a portable electronic apparatus characterized by comprising: monitoring outputs of plural sensor elements that are annularly arranged in a portable electronic apparatus and contact with which is detected; and detecting a predetermined turn including a forward and reverse turn in which a first direction turn and a second direction turn are continuous, the plural sensor elements continuously detecting contact in order in the first turning direction in the first direction turn and continuously detecting contact in order in the second direction opposite to the first turning direction in the second direction turn, and executing predetermined control.
